(19) United States
(12) Patent Application Publication
(10) Pub. No.: US 2026/0148005 A1
(43) Pub. Date: May 28, 2026

(54) SYSTEM AND METHOD FOR SIMULTANEOUSLY PREDICTING STANCE, SENTIMENT AND SARCASM FROM TEXT DATASET

(71) Applicants: King Fahd University of Petroleum and Minerals, Dhahran (SA); Saudi Data and Artificial Intelligence Authority (SDAIA), Riyadh (SA)

(72) Inventors: Nora Saleh ALTURAYEIF, Dhahran (SA); Hamzah Abdullah LUQMAN, Dhahran (SA); Moataz Aly Kamaleldin AHMED, Dhahran (SA)

(73) Assignees: King Fahd University of Petroleum and Minerals, Dhahran (SA); Saudi Data and Artificial Intelligence Authority (SDAIA), Riyadh (SA)

(21) Appl. No.: 18/962,319

(22) Filed: Nov. 27, 2024

(51) Int. Cl. G06F 40/30; G06F 40/126; G06F 40/284

(52) U.S. Cl. CPC G06F 40/30; G06F 40/126; G06F 40/284

(57) ABSTRACT

A system and a method for simultaneously predicting a stance, a sentiment, and a sarcasm from a text dataset. The system preprocesses input text based on user-defined parameters to obtain a preprocessed text batch. Shared layers encode and tokenize the preprocessed text batch to create a multi-task dataset with tokenized input text. Task-specific layers train a multi-task model with stance, sentiment, and sarcasm heads using the multi-task dataset. The system adjusts task weights of the multi-task model using a weighting scheme. The system predicts stance, sentiment, and sarcasm based on the trained multi-task model and adjusted task weights. This approach allows for efficient processing of text data, capturing complex interrelationships between stance, sentiment, and sarcasm.

### STATEMENT REGARDING PRIOR DISCLOSURE BY THE INVENTORS

Aspects of the present disclosure are described in “Enhancing stance detection through sequential weighted multi-task learning”, published in Social Network Analysis and Mining Volume 14, article number 7, which is incorporated herein by reference in its entirety.

### STATEMENT OF ACKNOWLEDGEMENT

Support provided by the Saudi Data and AI Authority (SDAIA) and King Fahd University of Petroleum and Minerals (KFUPM) under the SDAIA-KFUPM Joint Research Center for Artificial Intelligence Grant JRC-AI-RFP-05 are gratefully acknowledged.

### BACKGROUND

### Technical Field

The present disclosure relates to the field of natural language processing and machine learning, and specifically to systems and methods for multi-task learning in stance detection, sentiment analysis, and sarcasm detection from textual data.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The vast growth of social media platforms, online news outlets, and digital communication has led to an exponential increase in user-generated content in recent years. This unprecedented surge in online discourse has sparked an urgent need to develop automated tools and techniques capable of effectively analyzing the opinions and attitudes expressed within these expansive streams of text. Stance detection, also known as stance classification and stance prediction, a critical task within the field of Natural Language Processing (NLP), aims to identify the position or perspective of a writer toward a specific topic or entity by analyzing their written text and/or social media activity, such as preferences and connections. The applications of stance detection are diverse and encompass domains such as politics, marketing, and social media analysis.

Stance detection can be seen as a closely related problem to sentiment analysis, also known as opinion mining. Sentiment analysis primarily focuses on identifying the explicit sentiment polarity conveyed by a text, typically categorized as Positive, Negative, or Neutral. In contrast, stance detection aims to classify the viewpoint of a given text toward a specific target as Favor, Against, or None. Moreover, the target in stance detection is frequently of an abstract nature, such as ideological topics, and may not be explicitly referenced in the text, while sentiment analysis primarily deals with non-ideological subjects. In addition, the alignment between sentiment and stance within a given text exhibits variability. Consequently, a text may demonstrate positive sentiment while maintaining a stance against the target, or vice versa.

Stance detection poses significant challenges due to its subjective nature, where determining an individual's stance can be highly influenced by personal perspectives. Furthermore, the formation of concepts and opinions involved diverse expressions and linguistic compositions, adding to the difficulty of detection. Particularly in the realm of social media, stance detection becomes even more demanding. Social media is characterized by brevity, with limitations on character count (e.g., tweets limited to a maximum of 280 characters), extensive use of abbreviations, informality, and inconsistent grammar usage. Additionally, social media discussions tend to be fragmented and lack contextual information, further adding to the challenges faced in stance detection.

Conventional stance detection techniques have primarily focused on a per-target strategy, where separate models were trained for each target pair and evaluated on test data. Furthermore, the conventional techniques had mainly concentrated on training models solely for stance detection, without incorporating auxiliary tasks. However, there is potential for enhancing stance detection models by adopting a Multi-Task Learning (MTL) approach. MTL involved training a single model to perform multiple tasks simultaneously, sharing information between them to improve overall performance. MTL had been successful in various machine learning applications, offering advantages like reduced data requirements and improved generalization. However, there is a need in the field to investigate the potential of developing a joint neural architecture based on the MTL paradigm.

Furthermore, sarcasm, as a linguistic phenomenon, introduced nuances that could impact stance detection. Sarcasm often involved expressing a sentiment opposite to the intended message, which could potentially mislead stance detection models if not considered. Generally, misclassified samples are in texts that contain sarcastic comments. However, the interaction between sentiment and stance has been debated in the field. Hence, leveraging sarcasm detection, in addition to sentiment, as auxiliary tasks might lead to performance improvements since they provided valuable context.

Stance detection is a relatively new computational problem in the field of social computing. Despite its recent emergence, there has been a noteworthy endeavor to construct models specifically tailored for tackling stance detection. Conventional stance detection utilized feature engineering with a support vector machine (SVM) classifier, gradient boosting, and k-nearest neighbors (KNN). These conventional ML techniques fail to take into account the contextual meaning of words, resulting in relatively lower performance compared to other approaches.

There have been efforts to utilize supervised models for stance detection by employing deep learning architectures, including recurrent neural networks (RNNs), gated recurrent unit (GRU), and convolutional neural network (CNN), to provide explanations for stance labels by identifying the most relevant terms within topics in tweets. However, there are some limitations including the underperformance of certain attributes, such as tweet-specific content, and reliance on external resources for constructing sentiment and subjectivity annotations. Supervised learning-based models excel in accuracy and reliability when combined with appropriate algorithms and data representation. However, these models sometimes rely on external resources, such as lexicons, in addition to requiring a substantial supply of annotated data tailored to the specific task at hand. Obtaining such data can pose challenges in real-world NLP problems due to the vast language diversity and complexity involved. Consequently, this lack of appropriately annotated data can result in supervised learning failures within these scenarios.

Transfer learning in the field of NLP has witnessed a revolution with the emergence of pre-trained language models like OpenAI GPT, Google AI's BERT, and T5. Transfer learning is the process of leveraging knowledge from related domains, tasks, or languages by maximizing the use of unlabeled data in either the source or target domain. Within the realm of stance detection, the power of transfer learning by utilizing pre-trained language models trained on extensive unlabeled data, subsequently fine-tuning these models for the specific classification task has been explored. This approach is widely employed in stance detection for both domain adaptation and cross-lingual learning.

In domain adaptation, source and target documents are written in the same language but differ in terms of domain or target, such as political tweets versus social issues. On the other hand, cross-lingual learning involves source and target documents written in different languages, resulting in distinct feature spaces. While both domain adaptation and cross-lingual learning effectively address data scarcity and domain shift, they come with limitations. Domain adaptation may face challenges in selecting a suitable source domain and risks losing information during adaptation. Cross-lingual learning encounters challenges related to language structure differences and limited availability of parallel data for model training.

Multi-task learning (MTL) is a specific type of transfer learning where a model is trained on multiple tasks simultaneously. As well as being widely used in computer vision, speech recognition, and recommendation systems; it is being used recently in NLP. In the NLP field, MTL can jointly solve related problems to work toward more general language understanding. This approach has been shown to be effective in a wide range of NLP tasks, such as language translation, sentiment analysis, and text summarization.

None of the prior work has leveraged pre-trained language models, which have demonstrated significant advancements in various NLP tasks, in the MTL framework. Another aspect that has been somewhat overlooked in the existing literature is the exploration of different MTL architectures. In addition, conventional MTL architectures for stance detection have not taken into account task weighting, which can affect the overall performance of the model.

Accordingly, it is one object of the present disclosure to provide a system and a method for simultaneously predicting a stance, a sentiment, and a sarcasm from a text dataset. The present disclosure addresses the need for efficient and accurate analysis of user-generated content across multiple dimensions of opinion and expression. The present disclosure seeks to improve upon existing stance detection techniques by considering additional contextual information, such as sentiment and sarcasm, which can significantly impact the interpretation of stance. The present disclosure aims to overcome limitations of prior approaches by incorporating multi-task learning techniques and leveraging pre-trained language models. Furthermore, the present disclosure aims to offer a flexible approach that can be adapted to various languages and domains by utilizing pre-trained language models as foundational components.

### SUMMARY

In an exemplary embodiment, a system for simultaneously predicting a stance, a sentiment, and a sarcasm from a text dataset is described, comprising: a graphical processing unit having a memory; an input device configured to receive a plurality of user-defined parameters and connected to the graphical processing unit; and a display device configured to display a visualization of the stance, the sentiment, and the sarcasm and connected to the graphical processing unit and the memory, wherein the memory includes a program instruction configured to: preprocess, by input layers, an input text from the text dataset based on the plurality of user-defined parameters to obtain a preprocessed text batch; encode and tokenize, by shared layers, the preprocessed text batch to obtain a multi-task dataset having a tokenized input text; train, by task-specific layers, a multi-task model having a stance head, a sentiment head, and a sarcasm head with the multi-task dataset; adjust, by the task-specific layers, a plurality of task weights of the multi-task model with a weighting scheme; and predict the stance, the sentiment, and the sarcasm based on the multi-task model and the plurality of task weights.

In some embodiments, the program instruction is further configured to: transform the tokenized input text into a plurality of representations including a token embeddings, a segment embeddings, and a position embeddings; generate a unified representation by adding the plurality of representations; and tune the unified representation with a pre-trained language model.

In some embodiments, the multi-task model is selected from the group consisting of a parallel multi-task model and a sequential multi-task model.

In some embodiments, the weighting scheme is selected from the group consisting of a static weighted sum, a hierarchical weighting, and an uncertainty weighting.

In some embodiments, the stance head is a primary head, and the sentiment head and the sarcasm head are auxiliary heads.

In some embodiments, the visualization includes an attention visualization configured to provide a plurality of information of the text dataset.

In some embodiments, the plurality of information includes attention weights, a relevance level, and a prominence level.

In some embodiments, the multi-task model is a multi-target sequential multi-task learning model with hierarchal weighting (SMTL-HW).

In some embodiments, the plurality of user-defined parameters includes a maximum sequence length, a feature dimension, a batch size, a dropout rate, a patience parameter, a number of epochs, and a learning rate.

In some embodiments, the maximum sequence length is 128 tokens, the feature dimension is 786, the batch size is 32, the dropout rate is 0.1, the patience parameter is 5, the number of epochs is 20, and the learning rate is 2e⁻⁵.

In another exemplary embodiment, a method for simultaneously predicting a stance, a sentiment, and a sarcasm from a text dataset is described, comprising: preprocessing, by input layers, an input text from the text dataset based on a plurality of user-defined parameters to obtain a preprocessed text batch; encoding and tokenizing, by shared layers, the preprocessed text batch to obtain a multi-task dataset having a tokenized input text; training, by task-specific layers, a multi-task model having a stance head, a sentiment head, and a sarcasm head with the multi-task dataset; adjusting, by the task-specific layers, a plurality of task weights of the multi-task model with a weighting scheme; and predicting the stance, the sentiment, and the sarcasm based on the multi-task model and the plurality of task weights.

In some embodiments, the adjusting further comprises: transforming the tokenized input text into a plurality of representations including a token embeddings, a segment embeddings, and a position embeddings; generating a unified representation by adding the plurality of representations; and tuning the unified representation with a pre-trained language model.

In some embodiments, the multi-task model is selected from the group consisting of a parallel multi-task model and a sequential multi-task model.

In some embodiments, the weighting scheme is selected from the group consisting of a static weighted sum, a hierarchical weighting, and an uncertainty weighting.

In some embodiments, the stance head is a primary head, and the sentiment head and the sarcasm head are auxiliary heads.

In some embodiments, the method further comprises displaying an attention visualization configured to provide a plurality of information of the text dataset.

In some embodiments, the plurality of information includes attention weights, a relevance level, and a prominence level.

In some embodiments, the multi-task model is a multi-target sequential multi-task learning model with hierarchal weighting (SMTL-HW).

In some embodiments, the plurality of user-defined parameters includes a maximum sequence length, a feature dimension, a batch size, a dropout rate, a patience parameter, a number of epochs, and a learning rate.

In some embodiments, the maximum sequence length is 128 tokens, the feature dimension is 786, the batch size is 32, the dropout rate is 0.1, the patience parameter is 5, the number of epochs is 20, and the learning rate is 2e⁻⁵.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic diagram illustrating an overall architecture of a multi-task learning framework for stance detection, sentiment analysis, and sarcasm detection, according to certain embodiments.

FIG. 2A is a schematic diagram illustrating a structure of a parallel multi-task learning (PMTL) model, according to certain embodiments.

FIG. 2B is a schematic diagram illustrating a structure of a sequential multi-task learning (SMTL) model, according to certain embodiments.

FIG. 3 is a schematic diagram illustrating a simplification of a problem formulation in a single-task model compared to the multi-task model for simultaneously predicting a stance, a sentiment, and a sarcasm from a text dataset, according to certain embodiments.

FIG. 4 is a schematic diagram depicting the training intervals of two tasks T1 and T2 in the PMTL model versus the SMTL model, according to certain embodiments.

FIG. 5 is an exemplary flowchart of a method for simultaneously predicting a stance, a sentiment, and a sarcasm from a text dataset, according to certain embodiments.

FIG. 6 is an illustration of a non-limiting example of details of computing hardware used in a graphical processing unit of the system, according to certain embodiments.

FIG. 7 is an exemplary schematic diagram of a data processing system used within the graphical processing unit, according to certain embodiments.

FIG. 8 is an exemplary schematic diagram of a processor used with the graphical processing unit, according to certain embodiments.

FIG. 9 is an illustration of a non-limiting example of distributed components which may share processing with a controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a system and method for simultaneously predicting a stance, a sentiment, and a sarcasm from a text dataset. The system and method of the present disclosure incorporate two multi-task learning (MTL) models: Parallel Multi-Task Learning (PMTL) and Sequential Multi-Task Learning (SMTL). These models leverage pre-trained language models in the MTL framework to enhance stance detection through the incorporation of sentiment analysis and sarcasm detection tasks. The present disclosure utilize four task weighting techniques to enhance the performance of the MTL models. The system and method are configured to address the complexity of implementing MTL with Transformer-based architectures by providing a flexible and straightforward architecture that requires only the addition of a task head to the network. The present disclosure aims to enhance the performance of stance detection within an MTL framework by evaluating various weighting schemes that account for the related tasks of sentiment classification and sarcasm detection. The present disclosure provides a comprehensive evaluation and analysis to compare different combinations of the machine learning models with various task weighting schemes, and demonstrate the advantages of developing a multi-target model in contrast to specific-target models, with thorough assessment on benchmark datasets in both English and Arabic. The system and method of the present disclosure achieve state-of-the-art results in stance detection, with the multi-target sequential MTL model with hierarchal weighting (SMTL-HW) surpassing several strong baselines.

The present disclosure implements task weighting, which is an important factor in multi-task learning models. In a multi-task setting, the relative importance of each task can vary, and the system must be able to reflect this in its predictions. The present disclosure achieves this through the use of task weights, which reflect the relative importance of each task to the overall objective. The present disclosure implements task weighting approaches that can be categorized as equal, proportional, and learning weighting. Equal weighting assigns the same weight to each task loss.

The present disclosure also implements proportional weighting, which assigns weights to each task loss in proportion to their relative importance. Some embodiments of the present disclosure may use heuristics or domain knowledge to manually assign weights to each task. Additionally, some embodiments of the present disclosure may implement learning weighting, an advanced approach in which the optimal weight for each task loss is determined during the training process by minimizing a loss function that combines losses from all tasks, with task-specific weights treated as variables. Through the process, some embodiments in the present disclosure may determine the optimal weights that minimize the overall loss by implementing and evaluating these weighting schemes for stance detection. The effectiveness of different task may be evaluated weighting schemes on different types of datasets and assesses their generalizability to different domains.

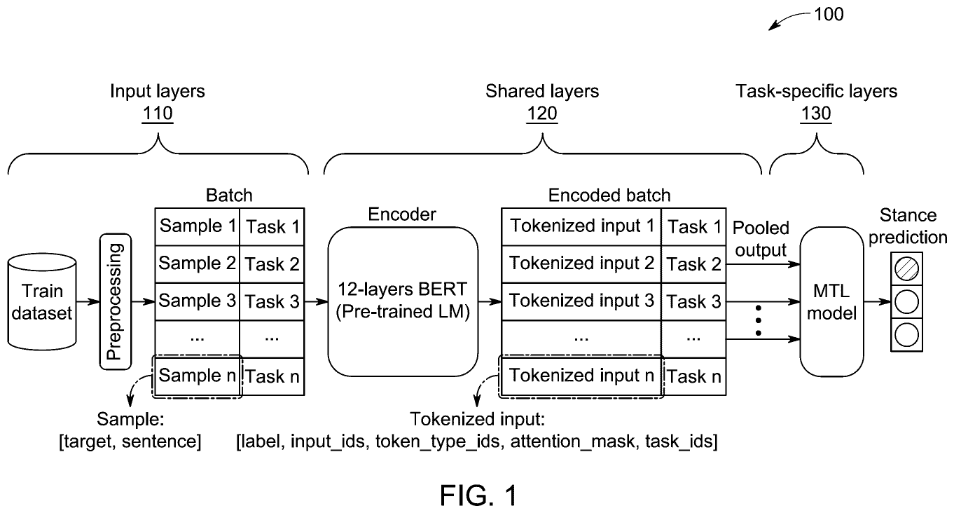

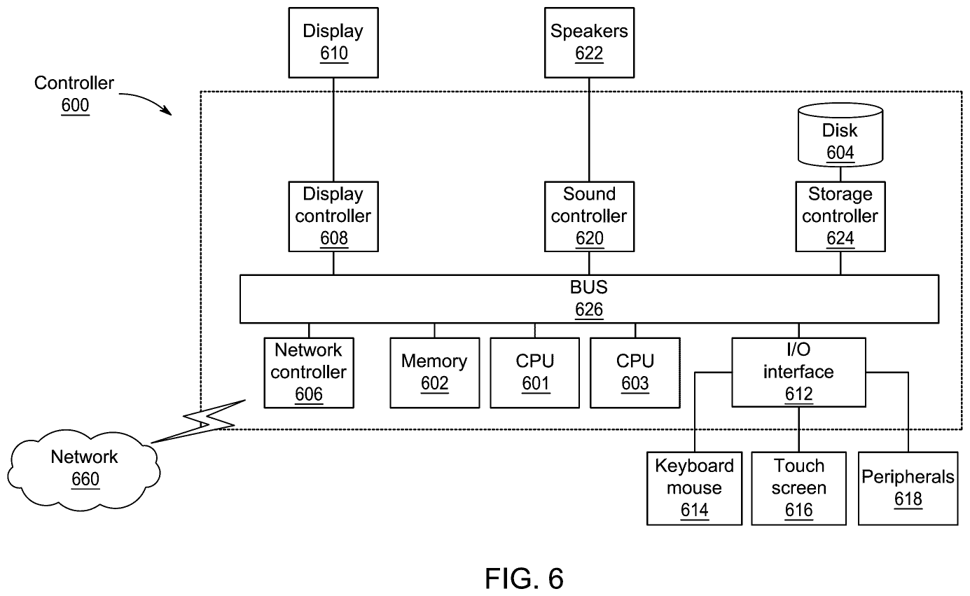

Referring to FIG. 1, illustrated is a schematic diagram of an overall architecture of a system (as represented by reference numeral 100) implementing multi-task learning framework for stance detection, sentiment analysis, and sarcasm detection. Table 1 (below) presents two tweet examples showcasing contrasting stance and sentiment labels. Hashtags in the examples, denoted by the ‘#’ symbol, are used in social media to categorize content and facilitate topic identification. The system 100 is implemented for simultaneously predicting a stance, a sentiment, and a sarcasm from a text dataset. The system 100 includes a graphical processing unit (GPU) having a memory (as discussed later in detail in reference to FIGS. 6-8). The system 100 utilizes the computational power of the GPU to efficiently process the complex neural network calculations required for the multi-task learning model. The memory of the GPU stores the model parameters, input data, and intermediate results during processing. The system 100 further includes an input device (again, discussed later in detail in reference to FIGS. 6-8). The input device is configured to receive a plurality of user-defined parameters. The input device is connected to the graphical processing unit, allowing for direct communication of the user-defined parameters to the graphical processing unit.

TABLE 1
Example of stance detection

| Text | Target | Stance | Sentiment |
|---|---|---|---|
| Republicans in the White House | Hillary | Against | Positive |
| will make America great again! | Clinton | | |
| #Trump #educateyourself | | | |
| And an even worse place from | Legalization | Favor | Negative |
| which to make medical | of Abortion | | |
| decisions FOR OTHER | | | |
| PEOPLE #mybodymychoice | | | |
| #notyours #notgovt | | | |

The system 100, as illustrated in FIG. 1, outlines an exemplary framework of the MTL models. The models, as implemented in the system 100, are trained to simultaneously predict three tasks: stance, sentiment, and sarcasm. While the primary focus lies on stance detection, the auxiliary tasks of sentiment analysis and sarcasm detection augment the comprehension of textual data for the model, consequently enhancing the performance of the system 100 on the primary task. The training process is validated with emphasis on the primary task of stance detection. As shown in FIG. 1, the system 100 includes three main components: input layers 110, shared layers 120, and task-specific layers 130.

In the system 100, the memory includes program instructions configured to preprocess, by the input layers 110, an input text from the text dataset based on the plurality of user-defined parameters to obtain a preprocessed text batch. The preprocessing stage is designed to prepare the text data for further analysis and model input. The preprocessing steps performed by the input layers 110 include removing URLs from the input text. This is achieved using a regular expression pattern to identify and eliminate web addresses from the text. The system also removes user mentions, which are typically identified by the ‘@’ symbol followed by a username. Further, the preprocessing step involves the removal of extra white spaces and line breaks, if present. These are trimmed to a single space to standardize the text format. For input text in Arabic language, the system 100 performs additional preprocessing steps. These include the removal of diacritics, which are marks added to letters to indicate specific pronunciations. The system also removes ‘tatweel’, which are elongation symbols used in Arabic script. Non-Arabic letters are also eliminated from the text during this stage. This preprocessing stage ensures that the input text is cleaned, standardized, and properly formatted for the subsequent stages of the multi-task learning process. The resulting preprocessed text batch is suitable for input into the shared layers 120 of the system 100.

The input layers 110 of the system 100 preprocess the training dataset, generating a batch of samples with associated task identifiers. The shared layers 120 include an encoder. In an embodiment, the encoder is a 12-layer BERT (Bidirectional Encoder Representations from Transformers) pre-trained language model. The encoder processes the input batch to produce an encoded batch of tokenized inputs with corresponding task identifiers. The task-specific layers 130 include a multi-task learning (MTL) model configured to take the pooled output from the shared layers 120 and generates predictions for the various tasks, including stance prediction. The system 100 implements hard parameter sharing, where all tasks share a set of hidden layers in the encoder, while each task has its own output layers or task heads. This architecture allows the system 100 to learn a shared feature representation that supports the modeling of all tasks simultaneously. The input layers 110 and the shared layers 120 remain consistent across different multi-task learning configurations, while the task-specific layers 130 may differ depending on the specific implementation.

In present embodiments, the plurality of user-defined parameters includes a maximum sequence length, a feature dimension, a batch size, a dropout rate, a patience parameter, a number of epochs, and a learning rate. These parameters are utilized by the system 100 to control various aspects of the preprocessing, training, and prediction processes. The maximum sequence length parameter determines the maximum number of tokens that can be processed in a single input sequence. In an embodiment, the maximum sequence length parameter is set to 128 tokens. Input texts longer than 128 tokens are truncated, while shorter texts are padded to reach this length. This standardization ensures consistent input size for the neural network model. The feature dimension parameter defines the size of the hidden representations in the model. The feature dimension parameter affects the capacity of the model to capture and represent complex patterns in the input data. In an embodiment, the feature dimension parameter is set to 786. The batch size parameter determines the number of samples that are processed together before the model weights are updated. In an embodiment, the batch size parameter is set to 32. A batch size of 32 provides a balance between computational efficiency and the stability of the process. The dropout rate parameter helps prevent overfitting by randomly setting a fraction of input units to 0 at each update during training. In an embodiment, the dropout rate parameter is set to 0.1. A dropout rate of 0.1 means that 10% of the neurons are randomly deactivated during each training iteration. The patience parameter determines the number of epochs with no improvement in the validation loss after which training will be stopped. In an embodiment, patience parameter is set to 5. This means that if the validation loss does not improve for 5 consecutive epochs, the training process is terminated to prevent overfitting. The number of epochs parameter defines the number of complete passes through the training dataset. In an embodiment, the number of epochs parameter is set to 20. The model trains on the entire dataset 20 times, unless early stopping is triggered by the patience parameter. The learning rate parameter determines the step size at each iteration while moving toward a minimum of the loss function. In an embodiment, the learning rate parameter is set to 2e⁻⁵. A learning rate of 2e⁻⁵ allows for fine-grained updates to the model weights during training. These specific parameter values have been empirically determined to provide optimal performance for the multi-task learning model in stance detection, sentiment analysis, and sarcasm detection tasks. However, it may be appreciated that the system 100 allows for these parameters to be adjusted based on specific dataset characteristics or task requirements.

For understanding, herein, let

$${\{ {D}_{T} \}}_{t = 1}^{T}$$

be data from tasks set, where T is the total number of tasks, and Dₜ is the training data for task t. Specifically,

$${D}_{t} = {( {x}_{i} , {y}_{i} )}_{i = 1}^{N}$$

is a set of N examples and the corresponding stance, sentiment, and sarcasm labels. Where xᵢ denotes the input text and yᵢ represents the label set for xᵢ. Table 2 (below) presents definitions of symbols used throughout the present disclosure. In some embodiments, a pipeline starts by preprocessing the input texts (xᵢ) which involves the removal of URLs, user mentions, extra white spaces, and line breaks. The pipeline starts by preprocessing the input texts (xᵢ) which involves the removal of URLs, user mentions, extra white spaces, and line breaks. For Arabic texts, an additional preprocessing step is performed, which entails the removal of diacritics, tatweel, and non-Arabic letters. Then, the input text is tokenized using, for example, a WordPiece tokenizer, which splits the text (tweets) into tokens compatible with BERT-based models. Tokenization allows for the generation of word vectors and effectively handles the issue of out-of-vocabulary (OOV) words by splitting them into root words and sub-words.

TABLE 2
Symbol definitions

| Symbol | Explanation |
|---|---|
| T | Total number of tasks t = (1, . . . , T)″ |
| Dₜ | Training data for task t |
| N | Number of examples in Dₜ |
| x | Input text x = (x₁, . . . , x_{N}) |
| yᵢ | Label set for xᵢ |
| Zₜ | Task descriptor generated in the shared layers |
| [symbol] ₜ | Cross-entropy loss for the task t |
| θ^{sh} | Shared parameters during the encoding stage |
| θ^{t} | Task-specific parameters for output decoder heads |

After completing these preprocessing steps, the system 100 tokenizes the cleaned input text using a WordPiece tokenizer. This tokenization process splits the text into tokens that are compatible with BERT-based models. The WordPiece tokenizer allows for the generation of word vectors and effectively handles the issue of out-of-vocabulary (OOV) words by splitting them into root words and sub-words. The system 100 then creates a multi-task dataset by combining samples from three task-specific datasets: stance, sentiment, and sarcasm. Each sample in this multi-task dataset consists of the preprocessed text, a label, a task type, and a task id. The task type for all three tasks is set to ‘seq_classification’ type, as they are all sentence classification tasks. The system 100 adds the task id of each sample as a new token called ‘task_ids’, which is used by the model to process the samples from each task properly.

The memory further includes program instructions configured to encode and tokenize, by the shared layers 120, the preprocessed text batch to obtain a multi-task dataset having a tokenized input text. That is, the system 100 encodes and tokenizes the preprocessed text batch using the shared layers 120 to obtain a multi-task dataset having the tokenized input text. This process is carried out by an encoder within the shared layers 120. In present embodiments, the program instruction is further configured to transform the tokenized input text into a plurality of representations including a token embeddings, a segment embeddings, and a position embeddings. In particular, the encoder takes in the tokenized input from the input layers 110 and transforms it into three distinct representations: token embeddings, segment embeddings, and position embeddings. The token embeddings represent the semantic meaning of each individual token in the input text. The segment embeddings differentiate between different segments of the input, which is particularly useful for tasks involving multiple sentences or text pairs. The position embeddings capture the sequential order of tokens in the input, allowing the model to understand the relative positions of words in the text.

The program instruction is further configured to generate a unified representation by adding the plurality of representations. Herein, the three representations, i.e., token embeddings, segment embeddings, and position embeddings, are then element-wise added together to generate a unified representation. This unified representation has a size of 128×768, where 128 corresponds to the maximum sequence length and 768 is the dimensionality of the embedding space. The program instruction is further configured to tune the unified representation with a pre-trained language model. Herein, the unified representation is subsequently fed into a large pre-trained language model for fine-tuning. In an embodiment, the pre-trained model is BERT (Bidirectional Encoder Representations from Transformers). Specifically, for Arabic text, the system 100 utilizes the AraBERT-twitter model, which is a version of BERT that has been pre-trained on Arabic Twitter data. For English text, the system 100 may use other variants of BERT or similar models like ROBERTa.

During the fine-tuning stage, the system 100 applies the learned contextual embeddings to individual tasks. To accommodate the multi-task setting, the system 100 creates a task-specific dictionary. This dictionary includes the encoded input and a task descriptor. The task descriptor is a label that identifies the specific task that the model is currently working on. The task descriptor may include details such as the task type (in this case, sequence classification), the possible labels for the task, the task name, and the associated loss function name. The loss function specified in the task descriptor allows for computing the task-specific loss during training of the model. This task-specific dictionary, containing the encoded input and the task descriptor, is then passed to the task-specific layers 130 (as discussed in the proceeding paragraphs).

In particular, the shared layers 120 allow the model to learn shared representations for each token in the input. These shared representations are subsequently leveraged by the task-specific layers 130 to enhance performance of the model on each respective task. The shared layers 120 consist of two modules: a shared encoder and a dictionary for the individual task models (task descriptor). The shared encoder takes in a tokenized input from the input layers and transforms it into three representations: token embeddings, segment embeddings, and position embeddings. These three representations are then element-wise added together to generate a unified representation. This unified representation, of size 128×768, is subsequently fed into the large pre-trained language model (BERT, in the present embodiments) to be fine-tuned. During the fine-tuning stage, the learned contextual embeddings are applied to individual tasks to accommodate the multi-task setting. Additionally, a task-specific dictionary is created, which includes the encoded input and the task descriptor Zₜ, a label that identifies the task that the model is currently working on. The dictionary is passed to the task-specific layers 130, which are responsible for predicting the output of the task, as explained in the proceeding paragraphs.

The memory further includes program instructions configured to train, by the task-specific layers 130, a multi-task model having a stance head, a sentiment head, and a sarcasm head with the multi-task dataset. That is, the system 100 trains a multi-task model using the task-specific layers 130. This multi-task model incorporates three distinct heads: the stance head, the sentiment head, and the sarcasm head. The training process utilizes the multi-task dataset as prepared and encoded in the previous steps. Herein, the stance head of the multi-task model is trained to classify the stance of the input text as ‘Favor’, ‘Against’, or ‘None’; the sentiment head is trained to categorize the sentiment as ‘Positive’, ‘Negative’, or ‘Neutral’; and the sarcasm head is trained to perform binary classification, determining whether the input text is ‘Sarcastic’ or ‘Non-sarcastic’.

During the training process, the system 100 uses a cross-entropy loss function for each task. The objective of this loss function is to measure the similarity between the probability distribution generated by the Softmax function and the actual category distribution. The system 100 penalizes incorrect predictions by promoting the negative log-likelihood of the correct prediction. The system 100 employs a hard parameter sharing approach, where all tasks share a set of hidden layers in the encoder, while each task has its own output layers or task heads. This approach allows the model to learn a shared feature representation that supports the modeling of all tasks, while still maintaining task-specific outputs. To prevent overfitting and improve generalization, the system 100 implements early stopping based on the patience parameter. If the validation loss does not improve for the specified number of epochs (as defined by the patience parameter), the training process is terminated.

In the present embodiments, the multi-task model is selected from a group consisting of a parallel multi-task model and a sequential multi-task model. These two model architectures offer different approaches to handling multiple tasks simultaneously. The parallel multi-task model (PMTL) implemented by the system 100 trains all tasks simultaneously and independently. In this configuration, the stance detection, sentiment analysis, and sarcasm detection tasks are learned in parallel. Each task has its own set of parameters in the task-specific layers, while sharing the lower layers of the network. The PMTL model allows for concurrent learning of all tasks, potentially capturing task-specific features efficiently. The sequential multi-task model (SMTL) implemented by the system 100 trains tasks both simultaneously and sequentially. This approach enables knowledge transfer between tasks. In an implementation of the SMTL model, the system 100 first trains the sarcasm detection task, followed by the sentiment analysis task, and finally the stance detection task. This sequential training allows the target task (stance detection) to benefit from the features and knowledge acquired during the training of the source tasks (sarcasm and sentiment analysis). In general, both the PMTL and SMTL models utilize the same preprocessing and encoding steps in the input layers 110 and the shared layers 120. The primary difference lies in how the task-specific layers are structured and trained. The system 100 allows for the selection of either the PMTL or SMTL architecture based on the specific requirements of the application or the characteristics of the dataset being analyzed.

More specifically, in an embodiment, the multi-task model is implemented as a multi-target sequential multi-task learning model with hierarchical weighting (SMTL-HW). The SMTL-HW model combines the benefits of sequential multi-task learning with a hierarchical weighting scheme to enhance performance across multiple targets and tasks. The SMTL-HW model is configured to handle multiple targets within the stance detection task, in addition to the sentiment analysis and sarcasm detection tasks. The hierarchical weighting scheme in the SMTL-HW model dynamically adjusts the importance of each task during the training process. In the early stages of training, the SMTL-HW model assigns larger weights to the lower-level tasks, specifically the sentiment analysis and sarcasm detection tasks. As training progresses, the SMTL-HW model gradually increases the weight assigned to the target task of stance detection. This hierarchical approach is based on the assumption that lower-level tasks are necessary for learning the target task. For example, understanding sentiment is often important for accurately determining stance. By initially focusing on these auxiliary tasks, the SMTL-HW model builds a strong foundation of language understanding before fine-tuning on the more complex task of stance detection.

In the present embodiments, the stance head is a primary head, and the sentiment head and the sarcasm head are auxiliary heads. This configuration reflects the primary objective of the system 100, which is to predict stance, with sentiment analysis and sarcasm detection serving as supporting tasks. The primary designation of the stance head is responsible for classifying the input text into stance categories such as ‘Favor’, ‘Against’, or ‘None’. Thus, the stance head receives the most attention in the later stages of training in the SMTL-HW model. Further, the auxiliary sentiment head categorizes the input text into sentiment classes such as ‘Positive’, ‘Negative’, or ‘Neutral’. Similarly, the auxiliary sarcasm head performs binary classification to determine whether the input text is ‘Sarcastic’ or ‘Non-sarcastic’. By designating the sentiment head and the sarcasm head as auxiliary tasks, the system 100 utilizes these related aspects of language to enhance the performance of the primary stance detection task. The features learned in these auxiliary tasks provide valuable context and better understanding of the text, which can be used for accurate stance detection, especially in cases where stance and sentiment may not align or where sarcasm may influence the perceived stance.

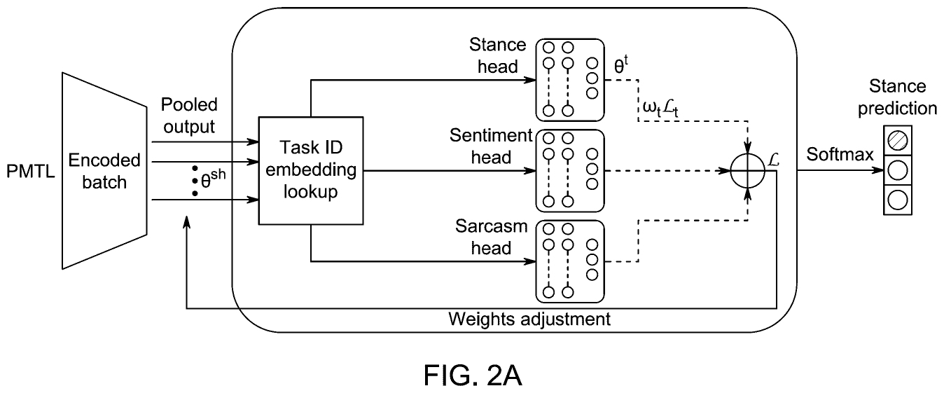

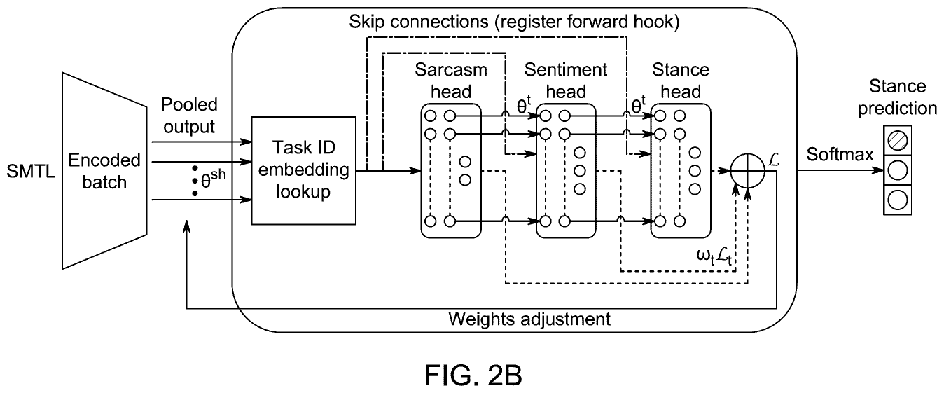

As discussed, PMTL involves training multiple tasks simultaneously with each task having its own set of parameters, while SMTL trains tasks simultaneously and sequentially where the knowledge learned from earlier tasks is transferred when training subsequent tasks. FIGS. 2A and 2B show a high-level flow of the PMTL and SMTL models, respectively. These task-specific layers define the MTL objective by jointly minimizing the loss of each task L, as follows:

$$obj ( MTL ) = {min}_{{θ}^{sh} , {θ}^{1} , … , {θ}^{T}} {\sum }_{t = 1}^{T} {ℒ}_{t} ( \{ {θ}^{sh} , {θ}^{T} \} , {D}_{t} ) \qquad ( 1 )$$

where [symbol] ₜ is the cross-entropy loss for the task t. Herein, as previously mentioned, the objective of this loss is to measure the similarity between the probability distribution generated by the Softmax function and the actual category distribution. Specifically, it penalizes wrong predictions by promoting the negative log-likelihood of the correct prediction. The shared learnable generated weights θ^{sh} are the weights learned by the shared encoder during the previous encoding stage, and the task-specific learnable generated weights θ^{t} are the weights learned by the task-specific decoder heads.

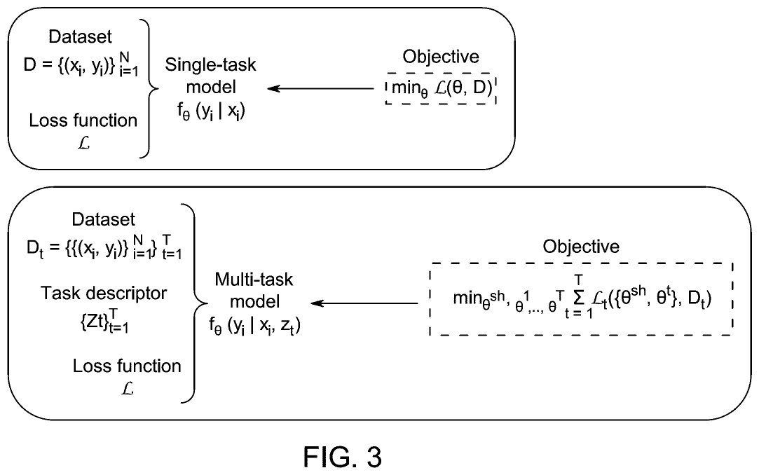

FIG. 3 simplifies the formulation of the problem and visually represents the distinction between the typical single-task model and the multitask model. As per FIG. 3, the MTL model f_{θ} can be defined as follows:

$${f}_{θ} ( {y}_{i} \vert {x}_{i} , {z}_{t} ) = obj ( MTL ) \qquad ( 2 )$$

where xᵢ is the input text and yᵢ is the label set for xᵢ from a given training data Dₜ for task t. The label set is varied based on the selected task (i.e., stance, sentiment, or sarcasm). Therefore, the model predicts the label yᵢ given the embeddings of the input xᵢ and the task descriptor Zₜ generated by the shared layers 120.

As discussed, the models include three components: the input layers 110, the shared layers 120, and the task-specific layers 130. While the input layers 110 and the shared layers 120 remain consistent in both PMTL and SMTL models, the layers associated with task-specific information differ. FIGS. 2A and 2B visually represent these distinctions. As shown in FIG. 2A, in PMTL, all tasks are simultaneously and independently learned. Conversely as shown in FIG. 2B, in SMTL, the tasks are sequentially learned, enabling the target task (i.e., stance) to capitalize on the features acquired from the source tasks (i.e., sarcasm and sentiment). As shown, PMTL and SMTL can be seen as being on different time intervals. Assuming there are two tasks; task T1 trained during the interval {t₁, t₂}, and task T2 trained during the interval {t₃, t₄}. In the PMTL setting, t₁=t₃ and t₂=t₄. That means, training commences and concludes simultaneously in both tasks. However, in STML, the second task is trained after training of the first task has started, where t₁<t₃ and t₃<t₄. Furthermore, a main characteristic of SMTL is that the features learned in the source task-specific layers are transferred to the target layers. Meanwhile, the task-specific layers are not shared between the different tasks in the PMTL paradigm.

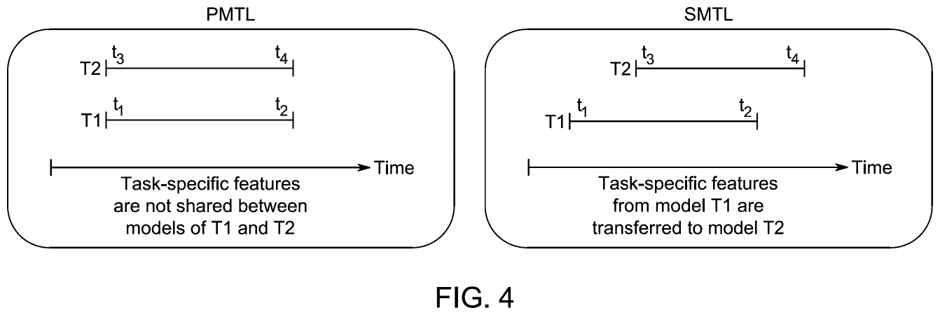

FIG. 4 illustrates the difference in the training intervals between the two paradigms. The SMTL model can inherently avoid the catastrophic forgetting, a common problem for sequential transfer learning. Catastrophic forgetting occurs when a model overfits the target domain, forgetting previously learned knowledge from the source tasks. To overcome this problem, the system 100 integrate the idea of MTL into sequential transfer learning. In particular, the SMTL model is designed to fulfil three main objectives. Firstly, it is trained on a comprehensive dataset that encompasses examples from all tasks, enabling simultaneous learning and prediction for multiple tasks. Secondly, it aims to minimize the loss of the target task along with the losses of the source tasks. This objective shared similarities with the PMTL objective (as presented in Equation 1) but distinguished itself by consistently including the loss of the source tasks to prevent catastrophic forgetting. Lastly, to facilitate sequential knowledge transfer, skip connections are integrated to extract “features” from the source models instead of “class logits.” To establish these connections and track the generated features and losses, an identity operator layer is introduced, ensuring the input passed through without alteration. The implementation of this mechanism involved employing a register forward hook function, which registered a global forward hook for all sub-models and was invoked after the “forward” function generated a hidden representation or computed an output (as shown in FIG. 2B).

Referring back to FIG. 1, the memory further includes program instructions configured to adjust, by the task-specific layers 130, a plurality of task weights of the multi-task model with a weighting scheme. This adjustment process enhances the performance of the multi-task model across all tasks, i.e., stance detection, sentiment analysis, and sarcasm detection. In the context of MTL, assigning appropriate task weights is important to ensure that the relative importance of each task is accurately reflected. The task weights may be calibrated to strike a balance between the performance of the main task and the contributions of related tasks. It may be noted that different tasks can have different objectives, and the task-specific loss function may differ based on the task. For instance, classification problems often employ cross-entropy loss, while regression problems usually utilize mean squared error.

It may be appreciated that when implementing MTL models, it is common for the tasks included to compete with each other. A phenomenon, known as task imbalance, occurs when we are unable to appropriately balance these tasks. In the context of MTL settings, it may be required to establish both a loss function and an optimizer to effectively train the deep learning model. The MTL loss function is typically a combination of multiple loss functions, corresponding to multiple tasks involved in the model training. If one loss is much larger than the others, then its corresponding task may dominate the training. In addition, some losses may converge faster or might be more important to the overall objective of the system 100. Furthermore, the optimization method is not aware of each individual task loss; thus, performance in MTL-based models is greatly influenced by the relative weights assigned to each task. For example, when all tasks except one are set to zero, then only that task will be optimized.

In the present implementation, the primary focus is to prioritize the stance detection task during the training process, while considering sentiment classification and sarcasm detection as auxiliary tasks. To achieve this, the MTL objective function is modified (as presented in Equation 1) by introducing a task importance coefficient, as follows:

$$obj ( MTL ) = {min}_{{θ}^{sh} , {θ}^{1} , . , {θ}^{T}} {\sum }_{t = 1}^{T} {ω}_{t} {ℒ}_{t} ( \{ {θ}^{sh} , {θ}^{T} \} , {D}_{t} ) \qquad ( 3 )$$

where ωₜ denotes the importance coefficient (i.e., weight) for task t. The assignment of appropriate weights to loss of each task is of importance. The simplest method is to set them equally, i.e., ω=1/T. It is common, however, to view weights as hyper-parameters that are set based on grid search or experience. Besides, weight adaptation methods formulate the MTL optimization problem by adaptively adjusting the weights of the tasks during training in accordance with a predefined heuristic.

The system 100 may implement several weighting schemes to adjust the task weights. In present embodiments, the weighting scheme is selected from the group consisting of a static weighted sum, a hierarchical weighting, and an uncertainty weighting. Each scheme offers a different approach to balancing the importance of tasks during the training process. In the Static Weighted Sum (SW) scheme, the system 100 assigns fixed weights to each task. These weights determine the importance coefficient of the respective task throughout the training process. The overall loss is calculated as a weighted sum of the individual task losses. In one embodiment, the system 100 sets the weight for the stance detection task to 0.6, the sentiment analysis task to 0.3, and the sarcasm detection task to 0.1. The Relative Weighted Sum (RW) scheme implemented by the system 100 is a dynamic weight assignment strategy. In this approach, the system 100 assigns a larger weight to the task with higher training loss during the optimization process. The weights are inferred by observing the loss values during model training, allowing for adaptive adjustment based on the difficulty of each task. In the Hierarchical Weighting (HW) scheme, the system 100 employs a dynamic weight assignment strategy that changes over the course of training. During the early stages of training, the system 100 assigns larger weights to the lower-level tasks (sentiment analysis and sarcasm detection). As training progresses, the system 100 gradually increases the weight assigned to the target task (stance detection). This approach is based on the assumption that lower-level tasks are necessary for learning the target task. The Uncertainty Weighting (UW) scheme implemented by the system 100 assigns weights based on the homoscedastic uncertainty associated with each task. Tasks with higher uncertainty receive lower weights compared to tasks with lower uncertainty. The system 100 achieves this by training the network to learn the log-variance of each task, which is then used to adjust the task weights. The system 100 allows for the selection of the most appropriate weighting scheme based on the specific requirements of the task and the characteristics of the dataset. The task-specific layers 130 utilize the selected weighting scheme to adjust the task weights during the training process, optimizing the performance of the multi-task model across all tasks.

In particular, in the SW scheme, a fixed weight is assigned to each task, which determines the importance coefficient of the respective task. Denoting the stance loss as [symbol] ₛₜ, sentiment loss as [symbol] ₛₑₙ, and sarcasm loss as [symbol] ₛₐᵣ; the overall loss ( [symbol] ) in the MTL optimization objective is defined as:

$$ℒ = {ω}_{1} {ℒ}_{st} + {ω}_{2} {ℒ}_{sen} + {ω}_{3} {ℒ}_{sar} \qquad ( 4 )$$

where ω₁, ω₂, and ω₃ control the weight of [symbol] ₛₜ, [symbol] ₛₑₙ, and [symbol] ₛₐᵣ, respectively. According to an empirical analysis, setting ω₁=0.6, ω₂=0.3, and ω₃=0.1 results in the best performance of the models. This suggests that the stance detection task is considered more crucial or has a higher impact on the overall objective of the MTL model. Furthermore, the sentiment analysis task is given more weight compared to the sarcasm task, possibly because sentiment analysis is deemed more relevant or informative in the context of stance detection.

In the RW approach, based on the intuition that tasks with higher training loss should receive more attention, a dynamic weight assignment strategy assigns a larger weight to the stance loss [symbol] ₛₜ during the optimization process. The loss weightings may be inferred by observing the loss values during model training. The overall loss [symbol] in the MTL optimization objective, incorporating the RW technique, is defined as:

$$ℒ = {ωℒ}_{st} + \frac{ω}{2} {ℒ}_{sen} + \frac{ω}{3} {ℒ}_{sar} \qquad ( 5 )$$

Herein, the network is trained to learn a single parameter ω, which serves as the weight for the stance detection task. The ω is assigned to prioritize the stance detection task, while relatively smaller weights are assigned to the sentiment and sarcasm tasks.

In the HW approach, a dynamic weight assignment strategy is employed that assigns a larger weight to the lower-level tasks (i.e., sentiment and sarcasm) during the early stages of training, and then assigns a larger weight to the target task (i.e., stance) during the later stages of the training. This is based on the assumption that the model should focus on learning the lower-level tasks first, as these tasks are necessary for learning the target task. For example, the sentiment task is necessary for learning the stance task, as the stance of a text is often related to its sentiment. In this approach, [symbol] is defined as:

$$ℒ = {ωℒ}_{st} + {ℒ}_{sen} + {ℒ}_{sar} \qquad ( 6 )$$

where the learnable generated weight ω is dynamically updated as follows:

$$ω = max ( min ( \frac{{ℒ}_{st}}{{ℒ}_{sen}} \cdot ω , 2 ) , 1 ) \qquad ( 7 )$$

The weight, ω, is utilized to regulate the relative significance of [symbol] ₛₜ based on empirical assumptions that [symbol] ₛₑₙ and [symbol] ₛₐᵣ carry equal importance. Initially set to 1, ω ensures equal emphasis on optimizing all tasks until [symbol] ₛₑₙ becomes relatively smaller than [symbol] ₛₜ. Consequently, as [symbol] ₛₜ increases, the model progressively focuses more on the stance detection task.

The UW approach is grounded on the notion that tasks with higher uncertainty should be assigned lower weights compared to tasks with lower uncertainty by using homoscedastic uncertainty, a task-specific uncertainty that remains constant for different input data. Homoscedastic uncertainty arises when tasks exhibit comparable difficulty levels, resulting in consistent model performance and consistent uncertainty or error across all tasks. In this work, the authors show that this approach outperforms the naive approach (i.e., the weighted linear sum of the losses) in the context of visual scene understanding, which includes scene geometry and semantics. While their work primarily focuses on regression, the present disclosure adapt their formulation for a classification problem. Equation 8 presents a simplified version of the derived MTL loss, with a comprehensive derivation (as available in Kendall et al.).

Specifically, in present implementation, homoscedastic uncertainty approach for task weighting is employed. In this approach, the overall loss [symbol] is defined as follows:

$$ℒ = {\sum }_{t = 1}^{T} \frac{1}{{σ}_{t}^{2}} {ℒ}_{t} + log {σ}_{t} \qquad ( 8 )$$

where σₜ is the homoscedastic uncertainty associated with each task. As a practical matter, we train the network to learn the log-variance,

$$log {σ}_{t}^{2} ,$$

since it is more numerically stable than

$${σ}_{t}^{2}$$

as [symbol] ₜ avoids any division by zero. It is evident from equation 8 (above) that the increase in uncertainty value may result in a smaller contribution of the task to the overall loss (i.e. if σₜ increases, the weight of [symbol] ₜ decreases). The second term, log σₜ, acts as a regularization term to prevent the model from learning a trivial solution by setting the uncertainty of all tasks (i.e., σₜ) to extremely high value.

The memory further includes program instructions configured to predict the stance, the sentiment, and the sarcasm based on the multi-task model and the plurality of task weights. This prediction stage utilizes the trained multi-task model to simultaneously classify new input text across all three tasks. As previously mentioned, for stance prediction, the system 100 uses the stance head of the multi-task model to classify the input text into one of three categories: ‘Favor’, ‘Against’, or ‘None’. The stance head generates a probability distribution over these three classes, and the system 100 selects the class with the highest probability as the predicted stance. Concurrently, the system 100 employs the sentiment head of the multi-task model to predict the sentiment of the input text. The sentiment classification categorizes the text as ‘Positive’, ‘Negative’, or ‘Neutral’. Similar to the stance prediction, the sentiment head produces a probability distribution over these three sentiment classes, and the system 100 selects the class with the highest probability as the predicted sentiment. For sarcasm detection, the system 100 utilizes the sarcasm head of the multi-task model to perform binary classification. The sarcasm head determines whether the input text is ‘Sarcastic’ or ‘Non-sarcastic’. The system 100 calculates the probability of the text being sarcastic and classifies it based on a predetermined threshold.

The system 100 incorporates the adjusted task weights in the prediction process. These weights, determined by the chosen weighting scheme (such as Static Weighted Sum, Relative Weighted Sum, Hierarchical Weighting, or Uncertainty Weighting), influence the relative importance of each task in the final prediction. For instance, in the case of Hierarchical Weighting, the stance prediction may be given more weight in the later stages of processing. The system 100 can process multiple input texts in batches, generating predictions for stance, sentiment, and sarcasm for each text in the batch. This batch processing capability allows for efficient analysis of large datasets or real-time processing of incoming text data. Such multi-task nature of the model allows the system 100 to leverage information from all three tasks in making predictions. For example, the sentiment and sarcasm predictions can provide additional context that helps refine the stance prediction, potentially improving overall accuracy compared to single-task models. The system 100 can output these predictions in various formats, such as probability distributions for each class, confidence scores, or discrete class labels, depending on the specific requirements of the application or subsequent analysis tasks.

The system 100 further includes a display device (discussed later in detail in reference to FIGS. 6-8) connected to the graphical processing unit and the memory. The display device is configured to display a visualization of the stance, the sentiment, and the sarcasm (i.e., predictions generated by the multi-task model). The visualization feature of the system 100 provides users with a graphical representation of outputs of the model, allowing for intuitive analysis of the results. In present configurations, the visualization includes an attention visualization configured to provide a plurality of information of the text dataset. Herein, the attention visualization is configured to provide a plurality of information about the text dataset. This attention visualization provides insights into how the model processes and attends to different parts of the input text when making predictions. The system generates this visualization by analyzing the attention weights between CLS token and all other tokens in the last layer of the model. The plurality of information provided by the attention visualization includes attention weights, a relevance level, and a prominence level for each token in the input text. The attention weights indicate the degree of importance the model assigns to each word or subword token when making its predictions. In the attention visualization, the system 100 may represent these weights using color intensity, where darker colors indicate higher attention weights and thus greater significance to decision of the model. The relevance level displayed in the attention visualization indicates how relevant each token is to the specific task of stance detection, sentiment analysis, or sarcasm detection. The system 100 calculates this relevance based on the magnitude of the attention weights and their distribution across the input text. Tokens with higher relevance are those that the model considers more important for determining the stance, sentiment, or presence of sarcasm. The prominence level shown in the attention visualization represents how much a particular token stands out compared to others in the context of the specific classification task. The system 100 determines prominence by considering both the attention weight of a token and its position within the text. Tokens with high prominence are those that the model focuses on most heavily when making its predictions. Using this attention visualization, the system 100 provides users with a detailed view of which parts of the input text are most influential in the decision-making process of the model. For instance, in stance detection, the visualization may highlight key phrases or words that strongly indicate a particular stance. In sentiment analysis, the visualization may highlight emotionally charged words. For sarcasm detection, the visualization may highlight the contrasting elements or unexpected word combinations that signal sarcastic intent. The system 100 allows users to interact with the visualization, enabling them to explore decision-making process of the model for individual predictions. This feature aids in interpreting and explaining the model outputs, which is particularly valuable in applications where transparency and explainability are important, such as in social media analysis or opinion mining tasks.

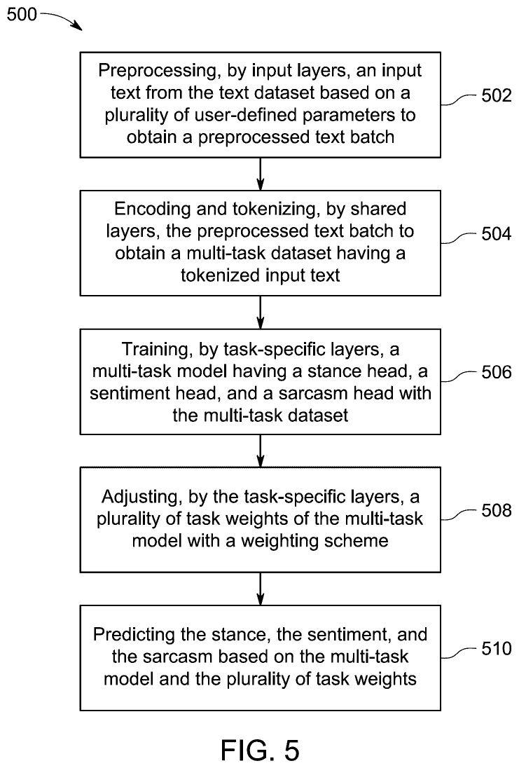

Referring to FIG. 5, the present disclosure further provides a method (as represented by a flowchart, referred by reference numeral 500) for simultaneously predicting a stance, a sentiment, and a sarcasm from a text dataset. The method 500 includes a series of steps. These steps are only illustrative, and other alternatives may be considered where one or more steps are added, one or more steps are removed, or one or more steps are provided in a different sequence without departing from the scope of the present disclosure. Various variants disclosed above, with respect to the aforementioned system 100 apply mutatis mutandis to the present method 500.

At step 502, the method 500 includes preprocessing, by the input layers 110, an input text from the text dataset based on the plurality of user-defined parameters to obtain the preprocessed text batch. That is, the method 500 begins with preprocessing, performed by the input layers 110, of an input text from the text dataset. This preprocessing is based on the plurality of user-defined parameters and results in the preprocessed text batch. Herein, the plurality of user-defined parameters includes the maximum sequence length, the feature dimension, the batch size, the dropout rate, the patience parameter, the number of epochs, and the learning rate. Specifically, the maximum sequence length is 128 tokens, the feature dimension is 786, the batch size is 32, the dropout rate is 0.1, the patience parameter is 5, the number of epochs is 20, and the learning rate is 2e⁻⁵. The preprocessing steps include removing URLs, user mentions, extra white spaces, and line breaks from the input text. For Arabic text, additional preprocessing steps such as removing diacritics, tatweel (elongation symbols), and non-Arabic letters are performed.

At step 504, the method 500 includes encoding and tokenizing, by the shared layers 120, the preprocessed text batch to obtain a multi-task dataset having a tokenized input text. Herein, the method 500 continues with encoding and tokenizing, carried out by the shared layers 120, of the preprocessed text batch. This step produces the multi-task dataset having the tokenized input text. In present embodiments, the encoding and tokenizing further comprises transforming the tokenized input text into the plurality of representations including a token embeddings, the segment embeddings, and the position embeddings; generating the unified representation by adding the plurality of representations; and tuning the unified representation with the pre-trained language model. That is, the encoding process transforms the input into token embeddings, segment embeddings, and position embeddings, which are then combined into a unified representation. This representation is fed into a pre-trained language model, such as BERT or AraBERT-twitter, for fine-tuning.

At step 506, the method 500 includes training, by the task-specific layers 130, the multi-task model having the stance head, the sentiment head, and the sarcasm head with the multi-task dataset. That is, the next step in the method 500 involves training, performed by the task-specific layers 130, of the multi-task model. This multi-task model incorporates the stance head, the sentiment head, and the sarcasm head, and is trained using the multi-task dataset. Herein, the stance head is the primary head, and the sentiment head and the sarcasm head are auxiliary heads. Further, the multi-task model is the multi-target sequential multi-task learning model with hierarchal weighting (SMTL-HW). The multi-task model is selected from the group consisting of the parallel multi-task model and the sequential multi-task model. That is, the training process may follow either the parallel multi-task learning (PMTL) approach, where all tasks are trained simultaneously, or the sequential multi-task learning (SMTL) approach, where tasks are trained both simultaneously and sequentially.

At step 508, the method 500 includes adjusting, by the task-specific layers 130, the plurality of task weights of the multi-task model with the weighting scheme. That is, the method 500 then includes adjusting, by the task-specific layers 130, the plurality of task weights of the multi-task model using the weighting scheme. Herein, the weighting scheme is selected from the group consisting of the static weighted sum, the hierarchical weighting, and an uncertainty weighting. This adjustment can be performed using various weighting schemes such as Static Weighted Sum (SW), Relative Weighted Sum (RW), Hierarchical Weighting (HW), or Uncertainty Weighting (UW). Each scheme offers the different approach to balancing the importance of tasks during the training process.

At step 510, the method 500 includes predicting the stance, the sentiment, and the sarcasm based on the multi-task model and the plurality of task weights. The stance prediction classifies the input text as ‘Favor’, ‘Against’, or ‘None’. The sentiment prediction categorizes the text as ‘Positive’, ‘Negative’, or ‘Neutral’. The sarcasm prediction determines whether the text is ‘Sarcastic’ or ‘Non-sarcastic’. These predictions are made simultaneously, using the shared representations and task-specific features learned by the multi-task model.

The method 500 further comprises displaying the attention visualization configured to provide a plurality of information of the text dataset. The method 500 generates the visual representation of the attention mechanisms within the multi-task model. The attention visualization is created by analyzing the attention weights between the CLS token and all other tokens in the final layer of the model. This analysis is performed for each prediction task, i.e., the stance detection, the sentiment detection, and the sarcasm detection. Herein, the plurality of information provided by the attention visualization includes the attention weights, the relevance level, and the prominence level for each token in the input text. The method 500 calculates and displays these three types of information for each word or subword token in the input. This visualization allows users to understand which parts of the input text are most influential in predictions of the model of stance, sentiment, and sarcasm, thereby increasing the interpretability of the multi-task learning approach.

### Example 1

Further details related to the present disclosure have been discussed in reference to an experiment. In some embodiments, a stance detection model specifically may be designed for the Arabic language, utilizing the Mawqif dataset. In another embodiments, experiments were also conducted on the SemEval-16 dataset, which is an English dataset widely used for stance detection. Both datasets consisted of Twitter posts that had been annotated with stance and sentiment labels. The Mawqif dataset also included annotations for sarcasm, providing additional valuable information for the model.

The Mawqif dataset stands as the pioneering and sole dataset made available to facilitate research and development of target-specific stance detection models in the Arabic language. The dataset comprised 4,121 tweets written in multiple dialects of Arabic and focusing on three topics: “women empowerment,” “COVID-19 vaccine,” and “digital transformation.” Each tweet was assigned a target and manually annotated with stance, sentiment, and sarcasm polarities. The stance annotations were ternary, indicating whether the stance of a tweet towards a specific target was in favor, against, or none if the text did not provide sufficient stance information. The sentiment annotations were also ternary, indicating whether the tweet was positive, negative, or neutral. The sarcasm annotations were binary, indicating whether the tweet was sarcastic, or non-sarcastic.

The SemEval-16 dataset is an English dataset for stance detection, which was first introduced in 2016 as part of a shared task. Furthermore, it has been widely used as a benchmark for stance detection research and has been the basis for several machine learning models. The dataset consisted of 4,163 tweets manually annotated with a stance label (favor, against, or none), as well as a sentiment label (positive, negative, or neutral). The dataset was collected during the 2016 US presidential election campaign and it covered five targets: “Atheism”, “Climate Change”, “Feminist Movement”, “Hillary Clinton”, and “Legalization of Abortion”. The detailed statistics of both Mawqif and SemEval-16 datasets are listed in Table 3 below.

TABLE 3
Data distribution of Mawqif dataset and SemEval-16 dataset.

| Dataset | Target | #Train | % Favor | % Against | % None | #Test | % Favor | % Against | % None |
|---|---|---|---|---|---|---|---|---|---|
| Mawqif | Covidvaccine | 1167 | 43.62 | 43.53 | 12.85 | 206 | 43.69 | 43.69 | 12.62 |
| | Digitaltrans. | 1145 | 76.77 | 12.40 | 10.83 | 203 | 76.85 | 12.32 | 10.84 |
| | Womenemp. | 1190 | 63.87 | 31.18 | 4.96 | 210 | 63.81 | 30.95 | 5.24 |
| | Total | 3502 | 61.34 | 29.15 | 9.51 | 619 | 61.39 | 29.08 | 9.53 |
| SemEval | Athesim | 513 | 17.9 | 59.3 | 22.8 | 220 | 14.5 | 72.7 | 12.7 |
| | Climatechange | 395 | 53.7 | 3.8 | 42.5 | 169 | 72.8 | 6.5 | 20.7 |
| | Feminism | 664 | 31.6 | 49.4 | 19 | 285 | 20.4 | 64.2 | 15.4 |
| | HillaryClinton | 689 | 17.1 | 57 | 25.8 | 295 | 15.3 | 58.3 | 26.4 |
| | Abortion | 653 | 18.5 | 54.4 | 27.1 | 280 | 16.4 | 67.5 | 16.1 |
| | Total | 2914 | 25.8 | 47.9 | 26.3 | 1249 | 23.1 | 51.8 | 25.1 |

As an integral component in the parallel multi-task learning (PMTL) and sequential multi-task learning (SMTL) models, fine-tuning was conducted on the AraBERT-twitter model. This process involved encoding both tweets and targets as hidden representations. The resultant model served as the backbone model for training the Mawqif dataset. In a similar vein, for the SemEval-16 dataset, fine-tuning was performed on ROBERTa, leveraging hidden representations that encoded both tweets and targets.

All experiments were run on a single graphical processing unit with 24 GB memory. The maximum sequence length of the input was set to 128 tokens, a feature dimension to 786, and the batch size to 32. Each of the models was fine-tuned for 20 epochs with a dropout rate of 0.1. A hyper-parameter, known as “patience” was set to 5, which denoted the number of epochs without improvement after which training would be stopped. Adam with decoupled Weight decay (AdamW) was selected for optimization with a learning rate of 2e⁻⁵. Compared to the Adam optimizer, the AdamW optimizer has better generalizability and results in a lower training loss. To prevent overfitting, weight decay was set to 1e⁻⁵. All experiments were performed with a fixed initialization seed by setting Pytorch global seed to 42. The hyper-parameters were selected empirically in these experiments. Table 4 (below) summarizes the hyper-parameter values used in the experiments.

TABLE 4
Hyper-parameter values

| Hyper-parameter | Value |
|---|---|
| Max. sequence length | 128 |
| Feature dimension | 768 |
| Batch size | 32 |
| Number of epochs | 20 |
| Dropout rate | 0.1 |
| Early stop patience | 5 |
| Optimizer | Adam W |
| Learning rate | 2e−5 |
| weight decay | 1e−5 |

As shown in Table 3, both datasets were split into training and testing sets. For all experiments, 15% of the training set was further split off for model development. It should be mentioned that the model was tuned only on the development set. The performance of the model on the test set was then used as a proxy for its ability to generalize to new inputs.

The models were evaluated using the macro-average F1 (F_{Mac}) and the micro-average F1 (F_{Mic}) to align with conventional stance detection methods that report their results using these metrics. First, the F1-score was computed for the “Favor” and “Against” classes as follows:

$${F}_{favor} = \frac{2 {P}_{favor} {R}_{favor}}{{P}_{favor} + {R}_{favor}} \qquad ( 9 )$$

$${F}_{against} = \frac{2 {P}_{against} {R}_{against}}{{P}_{against} + {R}_{against}} \qquad ( 10 )$$

where P and R denote precision and recall, respectively. Then, F_{Mac} was calculated for each target as follows:

$${F}_{Mac} = \frac{{F}_{favor} + {F}_{against}}{2} \qquad ( 11 )$$

It should be noted that the “none” class, a class that was scarcely in the data, was not disregarded during training. However, this class was not considered in the evaluation because only the “Favor” and “Against” labels were of interest in this task. This approach is consistent with other stance detection methods, where reporting results using F_{Mac} specifically for the “favor” and “against” stance labels is a common practice.

By averaging the individual F_{Mac} scores calculated for each target, the F_{Mac} across targets was obtained. This metric provided an overall performance measure that took into account imbalanced data, ensuring equal contribution from both majority and minority classes. Additionally, the results were reported using the F_{Mic} metric, which involved computing F_{favor} and F_{against} scores across all targets and then taking their average. This measure is particularly useful for models performing well on more frequent target classes. However, achieving a high F_{Mac} score requires the model to perform well across all target classes.

### Example 2

Further below, the performance of the models is presented and compared. The objective was to identify the most effective approach for target-specific stance detection, considering both the Mawqif and SemEval-16 datasets. In addition, the results are discussed and analysed in three dimensions. First, the performance of the two multi-task model models is discussed and compared with the single-task model. Second, the effect of task weighting on the performance of the models is analysed. Third, the performance of the multi-target classifier is evaluated compared to a target-specific classifier. Additionally, an attention visualization is provided to gain insights into which parts of the input text the models are paying more attention to when making their predictions. It should be noted that the analysis was performed on the test set. The outcomes of this section guided the selection of the best approach for stance detection.

The definitions of all the model variations are as follows:
PMTL: Parallel Multi-Task Learning model that leverages three tasks: stance, sentiment, and sarcasm. This model is illustrated in FIG. 2.
PMTL-sent: PMTL model that leverages two tasks: stance and sentiment.
PMTL-sarc: PMTL model that leverages two tasks: stance and sarcasm.
PMTL-SW: Best PMTL setting with static weighted loss.
PMTL-RW: Best PMTL setting with relative weighted loss.
PMTL-HW: Best PMTL setting with hierarchical weighted loss.
PMTL-UW: Best PMTL setting with uncertainty weighted loss.
SMTL-sarc-sent: Sequential Multi-Task Learning model that trains three tasks in the following order: sarcasm, sentiment, and stance. This model is illustrated in FIG. 2.
SMTL-sent-sarc: SMTL trains three tasks in the following order: sentiment, sarcasm, and stance.
SMTL-sent: SMTL trains two tasks, sentiment followed by stance.
SMTL-sarc: SMTL trains two tasks, sarcasm followed by stance.
SMTL-SW: Best SMTL setting with static weighted loss.
SMTL-RW: Best SMTL setting with relative weighted loss.
SMTL-HW: Best SMTL setting with hierarchical weighted loss.
SMTL-UW: Best SMTL setting with uncertainty weighted loss.

For understanding the effectiveness of multi-task learning in improving the performance of a stance detection task, the performance of the two architectures, PMTL and SMTL, without task weighting was compared. Table 5 (below) presents the performance of all models on Mawqif dataset, with “Overall” reports F1-scores calculated globally across all targets and using bold format for best within each model group. The performance was measured in terms of F1g-score for the “Favor” and “Against” classes (F_{favor}, F against), macro F1-score (F_{Mac}), and micro F1-score (F_{Mic}). For each model variation, three classifiers were trained on each target separately.

TABLE 5
F1-scores of multi-task models on Mawqif dataset reported for each individual target.

| COVID-19 Vaccine | | | Digital Transformation | | | Women Empowerment | | | Overall | |
|---|---|---|---|---|---|---|---|---|---|---|
| F_{favor} | F_{against} | F_{Mac} | F_{favor} | F_{against} | F_{Mac} | F_{favor} | F_{against} | F_{Mac} | F_{Mic} | F_{Mac} |

PMTL models

| | | | | | | | | | | | |
|---|---|---|---|---|---|---|---|---|---|---|---|
| PMTL-sent | 81.52 | 81.32 | 81.42 | 90.85 | 56.00 | 73.43 | 89.68 | 80.95 | 85.32 | 81.49 | 80.05 |
| PMTL-sarc | 81.82 | 80.43 | 81.13 | 90.18 | 55.81 | 73.00 | 89.45 | 81.82 | 85.64 | 80.19 | 79.92 |
| PMTL | 82.15 | 82.02 | 82.09 | 91.02 | 65.22 | 78.12 | 90.37 | 86.13 | 88.25 | 82.82 | 81.92 |

PMTL + Loss weighting models

| | | | | | | | | | | | |
|---|---|---|---|---|---|---|---|---|---|---|---|
| PMTL-SW | 82.66 | 83.05 | 82.86 | 90.96 | 68.38 | 79.67 | 91.91 | 87.22 | 89.56 | 83.61 | 84.03 |
| PMTL-RW | 80.23 | 80.43 | 80.33 | 89.81 | 63.16 | 76.48 | 90.65 | 81.89 | 86.27 | 81.21 | 81.03 |
| PMTL-HW | 82.44 | 83.61 | 83.02 | 90.52 | 59.09 | 74.81 | 91.10 | 83.87 | 87.49 | 81.54 | 81.77 |
| PMTL-UW | 81.71 | 78.79 | 80.25 | 89.85 | 55.81 | 72.83 | 90.58 | 84.85 | 87.71 | 79.51 | 80.26 |

SMTL models

| | | | | | | | | | | | |
|---|---|---|---|---|---|---|---|---|---|---|---|
| SMTL-sent | 79.04 | 79.38 | 79.21 | 89.30 | 51.16 | 70.23 | 91.73 | 85.51 | 88.62 | 79.81 | 79.35 |
| SMTL-sarc | 80.00 | 80.00 | 80.00 | 89.97 | 56.52 | 73.25 | 90.11 | 80.00 | 85.05 | 79.74 | 79.43 |
| SMTL-sent-sarc | 79.01 | 81.16 | 80.09 | 89.46 | 54.90 | 72.18 | 91.45 | 85.93 | 88.69 | 81.06 | 80.32 |
| SMTL-sarc-sent | 80.92 | 83.51 | 82.22 | 91.13 | 68.09 | 79.61 | 92.00 | 86.11 | 89.06 | 83.02 | 83.63 |

SMTL-sarc-sent + Loss weighting models

| | | | | | | | | | | | |
|---|---|---|---|---|---|---|---|---|---|---|---|
| SMTL-SW | 83.08 | 84.16 | 83.62 | 90.74 | 56.52 | 73.63 | 91.04 | 84.38 | 87.71 | 81.28 | 81.65 |
| SMTL-RW | 76.83 | 78.00 | 77.41 | 89.70 | 54.55 | 72.12 | 90.18 | 83.08 | 86.63 | 79.20 | 78.72 |
| SMTL-HW | 83.50 | 85.82 | 84.66 | 92.30 | 68.64 | 80.47 | 93.32 | 87.00 | 90.16 | 84.01 | 85.10 |
| SMTL-UW | 81.61 | 82.90 | 82.26 | 91.24 | 63.41 | 77.33 | 91.24 | 85.71 | 88.48 | 83.32 | 82.69 |

To assess generalization capability of the models, their performance was evaluated on SemEval-16 dataset, an English dataset. Testing on another language, such as English, provided a reliable estimate of the model's ability to generalize to new languages. Due to the distinct structural and grammatical differences between the English and Arabic languages, incorporating evaluations using English text aided in evaluating the robustness of the models. The performance of the models on the SemEval-16 dataset is presented in Table 6 (below), presenting the results obtained from training five classifiers individually for each target, with “Overall” reports F1-scores calculated globally across all targets and using bold format for best within each model group.

TABLE 6
F1-scores of multi-task models on SemEval-16 dataset reported for each individual target.

| Atheism | | | Climate change | | | Feminist movement | | | Hilary Clinton | | | Abortion legalization | | | Overall | |
|---|---|---|---|---|---|---|---|---|---|---|---|---|---|---|---|---|
| F_{favor} | F_{against} | F_{Mac} | F_{favor} | F_{against} | F_{Mac} | F_{favor} | F_{against} | F_{Mac} | F_{favor} | F_{against} | F_{Mac} | F_{favor} | F_{against} | F_{Mac} | F_{Mic} | F_{Mac} |

Multi-task models

| | | | | | | | | | | | | | | | | | |
|---|---|---|---|---|---|---|---|---|---|---|---|---|---|---|---|---|---|
| PMTL | 61.54 | 86.58 | 74.06 | 91.41 | 15.38 | 53.4 | 52.22 | 63.48 | 57.85 | 47.89 | 78.17 | 63.03 | 52.83 | 77.14 | 64.99 | 72.63 | 62.66 |
| SMTL | 59.15 | 86.26 | 72.71 | 91.27 | 16.67 | 53.97 | 53.85 | 67.35 | 60.60 | 52.27 | 80.00 | 66.14 | 57.14 | 78.16 | 67.65 | 73.63 | 64.21 |

PMTL + Loss weighting

| | | | | | | | | | | | | | | | | | |
|---|---|---|---|---|---|---|---|---|---|---|---|---|---|---|---|---|---|
| PMTL-SW | 63.16 | 87.09 | 75.13 | 92.98 | 29.38 | 61.18 | 54.44 | 73.02 | 63.73 | 61.70 | 79.65 | 70.67 | 57.55 | 78.53 | 68.04 | 74.83 | 67.75 |
| PMTL-RW | 50.60 | 80.68 | 65.64 | 90.91 | 28.57 | 59.74 | 52.23 | 73.62 | 62.92 | 60.00 | 80.23 | 70.12 | 59.32 | 76.42 | 67.87 | 74.75 | 65.26 |
| PMTL-HW | 57.89 | 85.71 | 71.80 | 91.05 | 16.67 | 53.86 | 54.02 | 71.20 | 62.61 | 56.1 | 77.38 | 66.74 | 54.90 | 77.81 | 66.36 | 73.81 | 64.27 |
| PMTL-UW | 61.11 | 87.01 | 74.06 | 91.34 | 16.67 | 54.00 | 48.31 | 68.81 | 58.56 | 38.24 | 78.72 | 58.48 | 54.21 | 77.97 | 66.09 | 70.83 | 62.24 |

SMTL + Loss weighting

| | | | | | | | | | | | | | | | | | |
|---|---|---|---|---|---|---|---|---|---|---|---|---|---|---|---|---|---|
| SMTL-SW | 62.79 | 85.32 | 74.06 | 90.98 | 15.38 | 53.18 | 53.99 | 72.45 | 63.22 | 60.87 | 81.98 | 71.42 | 54.39 | 77.06 | 65.72 | 74.79 | 65.52 |
| SMTL-RW | 61.76 | 88.10 | 74.93 | 91.54 | 15.38 | 53.46 | 54.44 | 71.10 | 62.77 | 56.10 | 82.76 | 69.43 | 52.17 | 72.95 | 62.56 | 74.14 | 64.63 |
| SMTL-HW | 67.57 | 87.79 | 77.68 | 92.55 | 28.57 | 60.56 | 55.00 | 72.51 | 63.76 | 61.95 | 82.35 | 72.15 | 58.85 | 79.34 | 69.10 | 75.42 | 68.65 |
| SMTL-UW | 62.16 | 86.67 | 74.41 | 91.95 | 15.38 | 53.67 | 51.14 | 71.75 | 61.44 | 48.78 | 78.92 | 63.85 | 46.34 | 77.38 | 61.86 | 71.45 | 63.05 |

As indicated by the results presented in Tables 5 and 6, the superiority of the SMTL approach over PMTL was observed in both datasets, namely Mawqif and SemEval-16. This observation held true regardless of task weighting, which is further elaborated upon later in the description.

Regarding incorporating sentiment and sarcasm tasks in stance detection models, the inclusion of both tasks in PMTL and SMTL conferred a significant advantage over models that solely focused on sentiment or sarcasm. As shown in Table 5, PMTL with both sentiment and sarcasm had the highest Macro F1 score of 81.92, which was around 2 points above PMTL-sent and PMTL-sarc. A similar conclusion was found for SMTL, which had the highest Macro F1 score of 83.63 when incorporating both tasks. This was 4 points higher than SMTL-sent and SMTL-sarc. Remarkably, the SMTL model trained on sarcasm first and then sentiment performed better than a model trained on sentiment and then sarcasm. When the model was trained on sarcasm first, it could potentially use the sentiment understanding it gained from sarcasm detection to improve its ability to identify stance-related sentiments in text. Overall, the results indicated that auxiliary tasks can significantly improve the performance of the main task.

In some embodiments, four task weighting schemes were introduced: static weighting (SW), relative weighting (RW), hierarchical weighting (HW), and uncertainty weighting (UW). The investigation focused on analysing their impact on the MTL models. The experimental results consistently revealed the positive influence of task weighting on the performance of both PMTL and SMTL models. This improvement was observed across the Mawqif and SemEval-16 datasets, as shown in Tables 5 and 6. Nevertheless, certain weighting schemes were more effective than others, as elucidated in the subsequent paragraphs.

The evaluation results for Mawqif dataset presented in Table 5 demonstrated that SW provided a clear advantage over other weighting schemes for the PMTL model, with a Macro F1 score of 84.03. This was 2 points higher than RW and HW, and 4 points higher than UW. On the other hand, for the SMTL model, HW had the highest overall Macro F1 score of 85.1. This was 3 points higher than UW, 4 points higher than SW, and 6 points higher than RW.

The same conclusion regarding PMTL also applied to SemEval-16 dataset. Table 6 showed that among all PMTL models, PMTL with SW achieved the highest F1 score of 67.75. This was 2 points higher than RW, 3 points higher than HW, and 5 points higher than UW. On the other hand, the SMTL model performed the best when combined with the HW weighting scheme, scoring an F1 of 68.65. This was 3, 4, and 5 points higher than SW, RW, and UW, respectively. Nevertheless, it is important to acknowledge that models relying on learnable weights exhibited slower training in comparison to those utilizing constant parameters.

To compare the multi-target classifier with the target-specific classifier, the performance metrics of the single-target classifiers were averaged and reported against the performance of the multi-target classifier. Tables 7 and 8 (below) show the comparison for Mawqif and SemEval-16 datasets, respectively, with bold format for best within each model group and underlined format for best F_{Mac} comparing between target-specific and multi-target. According to the reported results, combining all targets into a single classifier seemed to be a superior solution compared to training separate models for each target. This observation remained consistent for both datasets.

TABLE 7
F1-scores of multi-task models on Mawqif dataset
for overall target-specific vs. multi-target.

| Overalltarget-specific | | | Multi-target | | |
|---|---|---|---|---|---|
| F_{favor} | F_{against} | F_{Mac} | F_{favor} | F_{against} | F_{Mac} |

PMTL models

| | | | | | | |
|---|---|---|---|---|---|---|
| PMTL-sent | 88.13 | 74.85 | 80.05 | 88.38 | 78.80 | 83.59 |
| PMTL-sarc | 87.22 | 73.15 | 79.92 | 87.61 | 77.38 | 82.50 |
| PMTL | 89.70 | 75.13 | 83.03 | 89.09 | 78.98 | 84.03 |

PMTL + Lossweightingmodels

| | | | | | | |
|---|---|---|---|---|---|---|
| PMTL-SW | 88.63 | 78.59 | 84.03 | 89.32 | 80.22 | 84.77 |
| PMTL-RW | 86.99 | 75.42 | 81.03 | 88.57 | 80.43 | 84.50 |
| PMTL-HW | 87.98 | 75.10 | 81.77 | 88.89 | 79.45 | 84.17 |
| PMTL-UW | 87.04 | 71.97 | 80.26 | 88.71 | 78.95 | 83.83 |

SMTLmodels

| | | | | | | |
|---|---|---|---|---|---|---|
| SMTL-sent | 86.90 | 72.71 | 79.35 | 88.17 | 78.33 | 83.25 |
| SMTL-sarc | 87.00 | 72.47 | 79.43 | 87.92 | 76.88 | 82.40 |
| SMTL-sent-sarc | 87.31 | 74.81 | 80.32 | 88.54 | 78.74 | 83.64 |
| SMTL-sarc-sent | 87.07 | 78.98 | 83.63 | 89.74 | 78.40 | 84.07 |

SMTL-sarc-sent + Lossweightingmodels

| | | | | | | |
|---|---|---|---|---|---|---|
| SMTL-SW | 88.07 | 74.50 | 81.65 | 88.04 | 77.84 | 82.94 |
| SMTL-RW | 85.92 | 72.48 | 78.72 | 86.97 | 78.33 | 82.65 |
| SMTL-HW | 89.30 | 78.72 | 85.10 | 90.42 | 82.05 | 86.23 |
| SMTL-UW | 88.15 | 78.48 | 82.69 | 87.63 | 77.95 | 82.79 |

TABLE 8
F1-scores of multi-task models on SemEval-16 dataset
for overall target-specific vs. multi-target.

| Overalltarget-specific | | | Multi-target | | |
|---|---|---|---|---|---|
| F_{favor} | F_{against} | F_{Mac} | F_{favor} | F_{against} | F_{Mac} |

Multi-taskmodels

| | | | | | | |
|---|---|---|---|---|---|---|
| PMTL | 70.59 | 74.67 | 62.66 | 58.17 | 76.92 | 67.55 |
| SMTL | 71.02 | 76.23 | 64.21 | 62.32 | 79.61 | 70.96 |

PMTL + Lossweighting

| | | | | | | |
|---|---|---|---|---|---|---|
| PMTL-SW | 72.65 | 77.02 | 67.75 | 66.44 | 80.03 | 72.63 |
| PMTL-RW | 72.46 | 77.03 | 65.26 | 63.18 | 80.91 | 72.05 |
| PMTL-HW | 71.83 | 75.79 | 64.27 | 63.84 | 79.08 | 71.46 |
| PMTL-UW | 65.62 | 76.04 | 62.24 | 63.47 | 75.99 | 69.73 |

SMTL + Lossweighting

| | | | | | | |
|---|---|---|---|---|---|---|
| SMTL-SW | 72.14 | 77.43 | 65.52 | 67.14 | 74.3 | 70.72 |
| SMTL-RW | 71.31 | 76.96 | 64.63 | 66.88 | 77.59 | 72.24 |
| SMTL-HW | 73.07 | 77.77 | 68.65 | 67.02 | 78.96 | 73.23 |
| SMTL-UW | 66.20 | 76.70 | 63.05 | 64.35 | 77.86 | 71.10 |

These results have implications for the development of stance classification models. In particular, the findings suggested that it is beneficial to train models on multiple targets, rather than on a single target. This is likely because the multi-target model has access to a much larger amount of data. In addition, a multi-target model can learn to share information between the different targets to identify stances towards all of those targets. Thus, it will be more likely to learn generic stance characteristics rather than particular traits of stance towards a single target.

Furthermore, by examining the results presented in Tables 7 and 8, it was observed that the multi-target SMTL-HW model outperformed others, attaining an F_{Mac} score of 86.23 on the Mawqif dataset and 73.23 on the SemEval-16 dataset. Hence, it was concluded that the multi-target SMTL-HW model demonstrated the highest performance among the evaluated models.

Although both multi-target and single-target models showed good performance, there were some targets that were easier for the models to identify the stances towards. For example, in Mawqif dataset, all models performed best when considering the “women empowerment” target, as shown in Table 5. In the case of SemEval-16 dataset, Table 6 showed that all models performed best when considering the “Atheism” target. These findings suggested that tweets related to women empowerment or atheism may contain strong indicators that differentiate between instances expressing support and those expressing opposition.

As part of the analysis, attention visualizations were explored to offer insights into how the model processes and attends to input text. Specifically, the attention weights between the CLS token and all other tokens in the last layer of the best-performed model, multi-target SMTL-HW, were visualized by using LIME method. By examining these attention weights, a better understanding of which parts of the input text are most important for the model's predictions could be gained. It should be mentioned that the analysis was performed on the test set, which allowed for evaluation of the generalizability of the model to new and unseen data.

Table 9 (below) shows the attention weights of the last layer in SMTL-HW model for randomly selected input sentences whose labels were accurately predicted by SMTL-HW. In the visualizations, words with darker colors indicate greater significance in influencing the model's predictions. It was observed that SMTL-HW model exhibited the capability to effectively capture prominent entities and sentiments within the text. For instance, in the first sentence, SMTL-HW highlighted “alleged” and “capitalist,” which are non-trivial terms representing an opposing stance towards women's empowerment. In the second sentence, the model selected the words “compulsion”, “die”, and “fear” as highly relevant to the topic of the COVID-19 vaccine. Furthermore, the SMTL-HW model identified words that support the notion of digital transformation, such as “value,” “benefit,” and “traffic.” By attending to these terms, the model demonstrated an understanding of the positive aspects and advantages associated with digitization processes. Overall, the attention visualizations obtained from the SMTL-HW model provided insights into its ability to capture significant elements within the text. The model exhibited proficiency in identifying prominent entities and sentiments, thereby showcasing its effectiveness in understanding textual information.

TABLE 9
Visualization of attention scores from SMTL-HW
model on testing examples of Mawqif dataset, along
with their target and correct predictions.

| Attention Visualization Examples | Target | Prediction |
|---|---|---|
| [symbol] [symbol] | Women | Against |
| One of the [symbol] reasons for empowering | Empowerment | |
| women is that [symbol] benefit from the | | |
| taxes and [symbol] paid by women | | |
| [symbol] [symbol] [symbol] | COVID-19 | Against |
| [symbol] [symbol] | Vaccine | |
| I [symbol] to take it, why this [symbol] ? Either | | |
| vaccination or no work?? This [symbol] . I'm | | |
| willing to [symbol] from covid, but I [symbol] out | | |
| of [symbol] . Anyway, good luck to those who | | |
| take it, we [symbol] to do the same | | |
| [symbol] [symbol] [symbol] | Digital | Favor |
| Digital transformation [symbol] in | Transformation | |
| everything, be it for humans, [symbol] , | | |
| or the disabled, and the [symbol] are | | |
| countless and immeasurable. | | |

In order to provide a comprehensive evaluation, the performance of the best-performing model, i.e., the multi-target SMTL-HW, was further compared with the results of conventional methods. By doing so, insights into the advancements achieved by the approach compared to existing research could be gained. The comparisons are presented in Table 10 (below), where the results are retrieved from the original papers.

TABLE 10
Comparison with other stance detection
models on two benchmark datasets.

| Dataset | Category | Model | FMic | FMac |
|---|---|---|---|---|
| Mawqif | Single-task | AraBERT-twitter | 79.78 | 78.89 |
| | Multi-task | SMTL-HW (ours) | 85.31 | 86.23 |
| SemEval-16 | Single-task | BERT | 71.32 | 59.59 |
| | | RoBERTa | 70.01 | 59.22 |
| | Multi-task | JOINT | 69.22 | 60.16 |
| | | MTIN | 70.30 | 64.90 |
| | | AT-JSS-Lex | 72.33 | 65.33 |
| | | MT-LRM-BERT | 75.10 | 67.46 |
| | | SMTL-HW (ours) | 72.46 | 73.23 |

Regarding the Mawqif dataset, no prior systems had been developed for this dataset since it was recently released. Nonetheless, the top-performing model was assessed by comparing it to the model used when released. This model was a single-task model that fine-tuned the AraBERT-twitter model using hidden representations encoded from both tweets and targets. It is worth noting that this model followed the same approach as the backbone model, making it a suitable point of comparison.

Furthermore, the best performing model was evaluated on the SemEval-16 dataset by comparing it with previous top-performing models. SemEval, released in 2016, has been extensively utilized in the art, enabling meaningful comparisons with other existing approaches. By assessing the model on the SemEval-16 dataset, it could be effectively benchmarked against other state-of-the-art models in the field. The model was compared with the following models:
BERT, which is a single-task model that extends the pre-trained BERT language model by adding a linear classification layer to the hidden representation of the special CLS token.
ROBERTa, which is a single-task model that extends the pre-trained ROBERTa language model by adding a linear classification layer to the hidden representation of the special token.
JOINT, which is a joint model that leverages sentiment information to enhance stance detection without relying on an attention mechanism.
MTIN, which is a Multi-Task Interaction Network model that simultaneously learns stance and sentiment with a word-level task interaction and task-related graphs.
AT-JSS-Lex, which is a multi-task model that incorporates stance and sentiment lexicon to guide its attention mechanism.
MT-LRM-BERT, which is a multi-task model that employs a label relation matrix, sentiment classification, and opinion-towards classification to enhance stance detection, while leveraging BERT for network initialization.

As demonstrated in Table 10 (above), the SMTL-HW model achieved the highest F_{Mac} score in stance detection across two datasets. Specifically, on the Mawqif dataset, SMTL-HW exhibited a remarkable 7.3% improvement in F_{Mic} and 5.5% in F_{Mac} compared to the single-task AraBERT-twitter model. Similarly, on the SemEval-16 dataset, the single-task models (i.e., BERT and ROBERTa) exhibited subpar performance due to their disregard for the significance of sentiment information. Notably, SMTL-HW showed improvements of 12.9% and 13.2% in F_{Mac} compared to the BERT and ROBERTa models, respectively. Although existing multi-task models take into account sentiment information, they still obtained a lower performance on SemEval-16. In terms of F_{Mac}, the SMTL-HW model surpassed JOINT, MTIN, AT-JSS-Lex, and MT-LRM-BERT models by 12.3%, 7.6%, 7.1%, and 5%, respectively. These results highlighted the effectiveness of the main components incorporated in the SMTL-HW model, namely the sequential architecture, and task weighting.

### Example 3

Next, further details of the hardware description of a computing environment according to exemplary embodiments is described with reference to FIG. 6. In FIG. 6, a controller 600 is described is representative of the graphical processing unit of the system 100, in which the controller 600 is a computing device which includes a CPU 601 which performs the processes described above/below. The process data and instructions may be stored in memory 602. These processes and instructions may also be stored on a storage medium disk 604 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 601, 603 and an operating system such as Microsoft Windows 7, Microsoft Windows 8, Microsoft Windows 10, UNIX, Solaris, LINUX, Apple MAC-OS and other systems known to those skilled in the art.

The hardware elements in order to achieve the computing device may be realized by various circuitry elements, known to those skilled in the art. For example, CPU 601 or CPU 603 may be a Xenon or Core processor from Intel of America or an Opteron processor from AMD of America, or may be other processor types that would be recognized by one of ordinary skill in the art. Alternatively, the CPU 601, 603 may be implemented on an FPGA, ASIC, PLD or using discrete logic circuits, as one of ordinary skill in the art would recognize. Further, CPU 601, 603 may be implemented as multiple processors cooperatively working in parallel to perform the instructions of the inventive processes described above.

The computing device in FIG. 6 also includes a network controller 606, such as an Intel Ethernet PRO network interface card from Intel Corporation of America, for interfacing with network 660. As can be appreciated, the network 660 can be a public network, such as the Internet, or a private network such as an LAN or WAN network, or any combination thereof and can also include PSTN or ISDN sub-networks. The network 660 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 608, such as a NVIDIA GeForce GTX or Quadro graphics adaptor from NVIDIA Corporation of America for interfacing with display 610, such as a Hewlett Packard HPL2445w LCD monitor. A general purpose I/O interface 612 interfaces with a keyboard and/or mouse 614 as well as a touch screen panel 616 on or separate from display 610. General purpose I/O interface also connects to a variety of peripherals 618 including printers and scanners, such as an OfficeJet or DeskJet from Hewlett Packard.

A sound controller 620 is also provided in the computing device such as Sound Blaster X-Fi Titanium from Creative, to interface with speakers/microphone 622 thereby providing sounds and/or music.

The general purpose storage controller 624 connects the storage medium disk 604 with communication bus 626, which may be an ISA, EISA, VESA, PCI, or similar, for interconnecting all of the components of the computing device. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

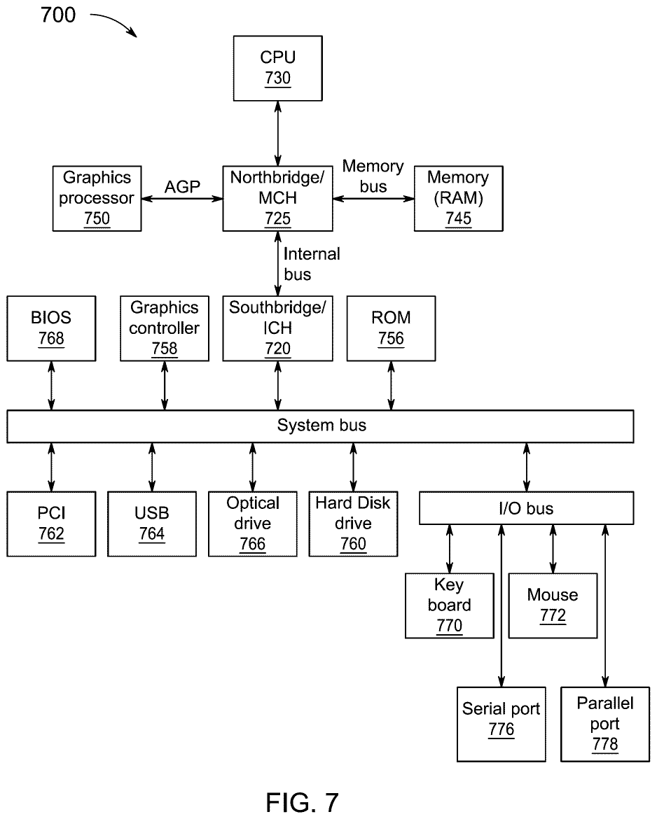

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 7.

FIG. 7 shows a schematic diagram of a data processing system, according to certain embodiments, for performing the functions of the exemplary embodiments. The data processing system is an example of a computer in which code or instructions implementing the processes of the illustrative embodiments may be located.

In FIG. 7, data processing system 700 employs a hub architecture including a north bridge and memory controller hub (NB/MCH) 725 and a south bridge and input/output (I/O) controller hub (SB/ICH) 720. The central processing unit (CPU) 730 is connected to NB/MCH 725. The NB/MCH 725 also connects to the memory 745 via a memory bus, and connects to the graphics processor 750 via an accelerated graphics port (AGP). The NB/MCH 725 also connects to the SB/ICH 720 via an internal bus (e.g., a unified media interface or a direct media interface). The CPU Processing unit 730 may contain one or more processors and even may be implemented using one or more heterogeneous processor systems.

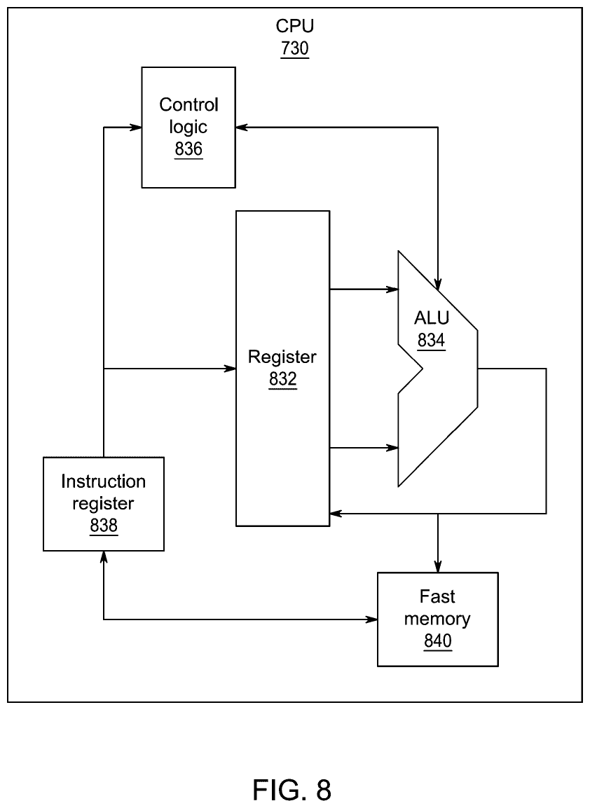

FIG. 8 illustrates one implementation of CPU 730. In one implementation, the instruction register 838 retrieves instructions from the fast memory 840. At least part of these instructions are fetched from the instruction register 838 by the control logic 836 and interpreted according to the instruction set architecture of the CPU 730. Part of the instructions can also be directed to the register 832. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 834 that loads values from the register 832 and performs logical and mathematical operations on the loaded values according to the instructions. The results from these operations can be feedback into the register and/or stored in the fast memory 840. According to certain implementations, the instruction set architecture of the CPU 730 can use a reduced instruction set architecture, a complex instruction set architecture, a vector processor architecture, a very large instruction word architecture. Furthermore, the CPU 730 can be based on the Von Neuman model or the Harvard model. The CPU 730 can be a digital signal processor, an FPGA, an ASIC, a PLA, a PLD, or a CPLD. Further, the CPU 730 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 7, the data processing system 700 can include that the SB/ICH 720 is coupled through a system bus to an I/O Bus, a read only memory (ROM) 756, universal serial bus (USB) port 764, a flash binary input/output system (BIOS) 768, and a graphics controller 758. PCI/PCIe devices can also be coupled to SB/ICH 788 through a PCI bus 762.

The PCI devices may include, for example, Ethernet adapters, add-in cards, and PC cards for notebook computers. The Hard disk drive 760 and CD-ROM 766 can use, for example, an integrated drive electronics (IDE) or serial advanced technology attachment (SATA) interface. In one implementation the I/O bus can include a super I/O (SIO) device.

Further, the hard disk drive (HDD) 760 and optical drive 766 can also be coupled to the SB/ICH 720 through a system bus. In one implementation, a keyboard 770, a mouse 772, a parallel port 778, and a serial port 776 can be connected to the system bus through the I/O bus. Other peripherals and devices that can be connected to the SB/ICH 720 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

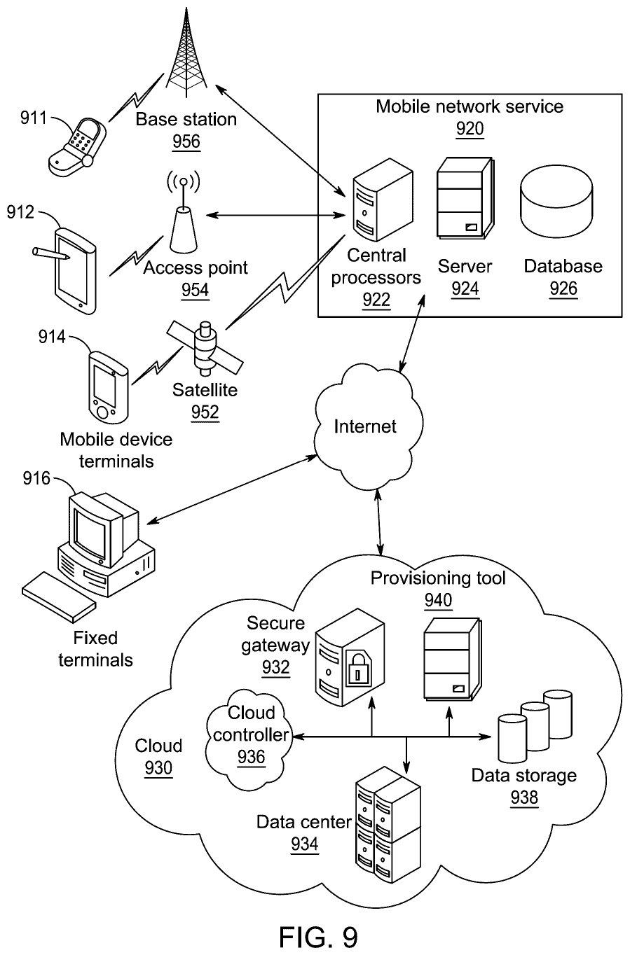

The functions and features described herein may also be executed by various distributed components of a system. For example, one or more processors may execute these system functions, wherein the processors are distributed across multiple components communicating in a network. The distributed components may include one or more client and server machines, such as cloud 930 including a cloud controller 936, a secure gateway 932, a data center 934, data storage 938 and a provisioning tool 940, and mobile network services 920 including central processors 922, a server 924 and a database 926, which may share processing, as shown by FIG. 9, in addition to various human interface and communication devices (e.g., display monitors 916, smart phones 910, tablets 912, personal digital assistants (PDAs) 914). The network may be a private network, such as a LAN, satellite 952 or WAN 954, or be a public network, may such as the Internet. Input to the system may be received via direct user input and received remotely either in real-time or as a batch process. Additionally, some implementations may be performed on modules or hardware not identical to those described. Accordingly, other implementations are within the scope that may be claimed.

While specific embodiments of the invention have been described, it should be understood that various modifications and alternatives may be implemented without departing from the spirit and scope of the invention. For example, different cellular automata rules or encryption algorithms could be employed, or alternative feature extraction and face recognition techniques could be integrated into the system.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A system for simultaneously predicting a stance, a sentiment, and a sarcasm from a text dataset, comprising:
a graphical processing unit having a memory;
an input device configured to receive a plurality of user-defined parameters and connected to the graphical processing unit; and
a display device configured to display a visualization of the stance, the sentiment, and the sarcasm and connected to the graphical processing unit and the memory,
wherein the memory includes a program instruction configured to:
preprocess, by input layers, an input text from the text dataset based on the plurality of user-defined parameters to obtain a preprocessed text batch;
encode and tokenize, by shared layers, the preprocessed text batch to obtain a multi-task dataset having a tokenized input text;
train, by task-specific layers, a multi-task model having a stance head, a sentiment head, and a sarcasm head with the multi-task dataset;
adjust, by the task-specific layers, a plurality of task weights of the multi-task model with a weighting scheme; and
determine the stance, the sentiment, and the sarcasm based on the multi-task model and the plurality of task weights.

2. The system of claim 1, wherein the program instruction is further configured to:
transform the tokenized input text into a plurality of representations including a token embedding, a segment embedding, and a position embedding;
generate a unified representation by adding the plurality of representations; and
tune the unified representation with a pre-trained language model.

3. The system of claim 1, wherein the multi-task model is selected from the group consisting of a parallel multi-task model and a sequential multi-task model.

4. The system of claim 1, wherein the weighting scheme is selected from the group consisting of a static weighted sum, a hierarchical weighting, and an uncertainty weighting.

5. The system of claim 1, wherein the stance head is a primary head, and the sentiment head and the sarcasm head are auxiliary heads.

6. The system of claim 1, wherein the visualization includes an attention visualization configured to provide a plurality of information of the text dataset.

7. The system of claim 6, wherein the plurality of information includes attention weights, a relevance level, and a prominence level.

8. The system of claim 1, wherein the multi-task model is a multi-target sequential multi-task learning model with hierarchal weighting (SMTL-HW).

9. The system of claim 1, wherein the plurality of user-defined parameters includes a maximum sequence length, a feature dimension, a batch size, a dropout rate, a patience parameter, a number of epochs, and a learning rate.

10. The system of claim 9, wherein the maximum sequence length is 128 tokens, the feature dimension is 786, the batch size is 32, the dropout rate is 0.1, the patience parameter is 5, the number of epochs is 20, and the learning rate is 2e⁻⁵.

11. A method for simultaneously predicting a stance, a sentiment, and a sarcasm from a text dataset, comprising:
preprocessing, by input layers, an input text from the text dataset based on a plurality of user-defined parameters to obtain a preprocessed text batch;
encoding and tokenizing, by shared layers, the preprocessed text batch to obtain a multi-task dataset having a tokenized input text;
training, by task-specific layers, a multi-task model having a stance head, a sentiment head, and a sarcasm head with the multi-task dataset;
adjusting, by the task-specific layers, a plurality of task weights of the multi-task model with a weighting scheme; and
predicting the stance, the sentiment, and the sarcasm based on the multi-task model and the plurality of task weights.

12. The method of claim 11, wherein the encoding and tokenizing further comprises:
transforming the tokenized input text into a plurality of representations including a token embeddings, a segment embeddings, and a position embeddings;
generating a unified representation by adding the plurality of representations; and
tuning the unified representation with a pre-trained language model.

13. The method of claim 11, wherein the multi-task model is selected from the group consisting of a parallel multi-task model and a sequential multi-task model.

14. The method of claim 11, wherein the weighting scheme is selected from the group consisting of a static weighted sum, a hierarchical weighting, and an uncertainty weighting.

15. The method of claim 11, wherein the stance head is a primary head, and the sentiment head and the sarcasm head are auxiliary heads.

16. The method of claim 11, further comprising:
displaying an attention visualization configured to provide a plurality of information of the text dataset.

17. The method of claim 16, wherein the plurality of information includes attention weights, a relevance level, and a prominence level.

18. The method of claim 11, wherein the multi-task model is a multi-target sequential multi-task learning model with hierarchal weighting (SMTL-HW).

19. The method of claim 11, wherein the plurality of user-defined parameters includes a maximum sequence length, a feature dimension, a batch size, a dropout rate, a patience parameter, a number of epochs, and a learning rate.

20. The method of claim 19, wherein the maximum sequence length is 128 tokens, the feature dimension is 786, the batch size is 32, the dropout rate is 0.1, the patience parameter is 5, the number of epochs is 20, and the learning rate is 2e⁻⁵.
